(19) United States
(12) Patent Application Publication
(10) Pub. No.: US 2023/0316657 A1
(43) Pub. Date: Oct. 5, 2023

(54) AUXILIARY DEVICE FOR AUGMENTED REALITY

(71) Applicant: Summer Robotics, Inc., Campbell, CA (US)

(72) Inventors: Gerard Dirk Smits, Los Gatos, CA (US); Steven Dean Gottke, Concord, CA (US)

(21) Appl. No.: 18/130,080

(22) Filed: Apr. 3, 2023

Related U.S. Application Data
(60) Provisional application No. 63/362,525, filed on Apr. 5, 2022.

(51) Int. Cl. G06T 19/00; G06T 7/246; G06T 7/70; G06F 3/01

(52) U.S. Cl. CPC G06T 19/00; G06T 7/246; G06T 7/70; G06F 3/013; G06T 2207/10028; G06T 2207/30241; G06T 2207/10016

(57) ABSTRACT

Embodiments are directed providing auxiliary devices for augmented reality. Images or video of a scene may be captured with frame cameras included in a mobile computer. A plurality of paths may be scanned across objects in the scene with beams provided by scanning devices that may be separate from the mobile computer. A plurality of events may be determined based on detection of beam reflections corresponding to the objects such that the beam reflections may be detected the scanning devices. A plurality of trajectories may be determined based on the plurality of paths and the plurality of events such that each trajectory may be a parametric representation of a one-dimensional curve segment in a three-dimensional space. The images or video of the scene may be augmented based on the plurality of trajectories.

### CROSS-REFERENCE TO RELATED APPLICATION

This application is a Utility Patent application based on previously filed U.S. Provisional Patent Application Ser. No. 63/362,525 filed on Apr. 5, 2022, the benefit of the filing date of which is hereby claimed under 35 U.S.C. § 119(e), and the contents of which is further incorporated in entirety by reference.

### TECHNICAL FIELD

The present innovations relates generally to machine sensing or machine vision systems, and more particularly, but not exclusively, to auxiliary device for augmented reality.

### BACKGROUND

Further, augmented reality using video streams has become a growing field. Analysis of video streams for 3-D information is often imprecise, particularly on devices such as mobile phones that have limited computational capacity. Furthermore, this may introduce disadvantageous latency into the final output that may reduce the sense of immersion. For example, commonly many frames of video need to be analyzed to build up information sufficient for immersion or other requirements related to objects or the scene being measured. Some motion of the device camera may be necessary if using Structure from Motion (SfM) or other techniques, but too much motion may lead to motion blur or other uncertainties; internal inertial sensors in the device may help disambiguate the motion of the phone, but may be less effective if on a moving vehicle, for instance. Conventional methods work best if the images have higher contrast to disambiguate features more easily in the scene; augmented reality overlaid on smooth objects with few features may often fail even under otherwise ideal conditions. Even if these techniques may be effective, they may disadvantageously require significant computation and for mobile device may cause an undesirable load on batteries. Although some phones or mobile devices may have additional features such as a limited LIDAR or other approaches to obtain additional 3-D data to supplement the information provided by device cameras, these features disadvantageous in terms of cost or energy consumption. Thus, it is with respect to these considerations and others that the present innovations have been made.

### BRIEF DESCRIPTION OF THE DRAWINGS

Non-limiting and non-exhaustive embodiments of the present innovations are described with reference to the following drawings. In the drawings, like reference numerals refer to like parts throughout the various figures unless otherwise specified. For a better understanding of the described innovations, reference will be made to the following Detailed Description of Various Embodiments, which is to be read in association with the accompanying drawings, wherein:

FIG. 1 is a perspective view of a user using an auxiliary 3-D capture device to augment reality in a scene in accordance with one or more of the various embodiments;

FIG. 2A is a perspective view of one type of scanning device in accordance with one or more of the various embodiments;

FIG. 2B is a perspective view of an alternate configuration of a scanning device in accordance with one or more of the various embodiments;

FIG. 2C is a perspective view of an alternate configuration of a scanning device in accordance with one or more of the various embodiments;

FIG. 3 is a process for combining information from a scanning device and another camera to implement augmented reality in accordance with one or more of the various embodiments;

FIG. 4A is a perspective view of a scene illuminated by a scanning device in accordance with one or more of the various embodiments;

FIG. 4B is a perspective view of the scene in 4B as also imaged by another camera in accordance with one or more of the various embodiments;

FIG. 4C is a perspective view of another scene illuminated by a scanning device in accordance with one or more of the various embodiments;

FIG. 5 is a cross-section view of a vehicle where a user is using an auxiliary 3-D capture device to perform augmented reality in a scene in accordance with one or more of the various embodiments;

FIG. 6A is a perspective view of a scene where two users are performing augmented reality on the same scene in accordance with one or more of the various embodiments;

FIG. 6B is an overhead view of a scene where two users are performing augmented reality on the same scene in accordance with one or more of the various embodiments;

FIG. 7 illustrates a system environment in which various embodiments may be implemented;

FIG. 8 illustrates a schematic embodiment of a client computer;

FIG. 9 illustrates a schematic embodiment of a network computer;

FIG. 10 illustrates a logical representation of sensors and sensor output information for auxiliary devices for augmented reality in accordance with one or more of the various embodiments; and

FIG. 11 illustrates a logical schematic of a system for auxiliary devices for augmented reality in accordance with one or more of the various embodiments.

### DETAILED DESCRIPTION OF VARIOUS EMBODIMENTS

Various embodiments now will be described more fully hereinafter with reference to the accompanying drawings, which form a part hereof, and which show, by way of illustration, specific exemplary embodiments by which the innovations may be practiced. The embodiments may, however, be embodied in many different forms and should not be construed as limited to the embodiments set forth herein; rather, these embodiments are provided so that this disclosure will be thorough and complete, and will fully convey the scope of the embodiments to those skilled in the art. Among other things, the various embodiments may be methods, systems, media or devices. Accordingly, the various embodiments may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments may be readily combined, without departing from the scope or spirit of the present innovations.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

For example, embodiments, the following terms are also used herein according to the corresponding meaning, unless the context clearly dictates otherwise.

As used herein the term, “engine” refers to logic embodied in hardware or software instructions, which can be written in a programming language, such as C, C++, Objective-C, COBOL, Java™, PHP, Perl, JavaScript, Ruby, VBScript, Microsoft .NET™ languages such as C#, or the like. An engine may be compiled into executable programs or written in interpreted programming languages. Software engines may be callable from other engines or from themselves. Engines described herein refer to one or more logical modules that can be merged with other engines or applications, or can be divided into sub-engines. The engines can be stored in non-transitory computer-readable medium or computer storage device and be stored on and executed by one or more general purpose computers, thus creating a special purpose computer configured to provide the engine.

As used herein the terms “scanning signal generator,” or “signal generator” refer to a system or a device that may produce a beam that may be scanned/directed to project into an environment. For example, scanning signal generators may be fast laser-based scanning devices based on dual axis microelectromechanical systems (MEMS) that are arranged to scan a laser in a defined area of interest. The characteristics of scanning signal generator may vary depending on the application or service environment. Scanning signal generators are not strictly limited to lasers or laser MEMS, other types of beam signal generators may be employed depending on the circumstances. Critical selection criteria for scanning signal generator characteristics may include beam width, beam dispersion, beam energy, wavelength(s), phase, or the like. Scanning signal generator may be selected such that they enable sufficiently precise energy reflections from scanned surfaces or scanned objects in the scanning environment of interest. The scanning signal generators may be designed to scan various frequencies, including up to 10s of kHz. The scanning signal generators may be controlled in a closed loop fashion with one or more processors that may provide feedback about objects in the environment and instructs the scanning signal generator to modify its amplitudes, frequencies, phase, or the like.

As used herein, the terms “event sensor, or” “event camera” refer to a device or system that detects reflected energy from scanning signal generators. Event sensors may be considered to comprise an array of detector cells that are responsive to energy reflected from scanning signal generators. Event sensors may provide outputs that indicate which detector cells are triggered and the time they are triggered. Event sensors may be considered to generate sensor outputs (events) that report the triggered cell location and time of detection for individual cells rather than being limited to reporting the state or status of every cell. For example, event sensors may include event sensor cameras, SPAD arrays, SiPM arrays, or the like.

As used herein the terms “image sensor,” or “frame camera” refer to a device or system that can provide electronic scene information (electronic imaging) based on light or other energy collected at surface the image sensor. Conventionally, image sensors may be comprised of charge-coupled devices (CCDs) or complementary metal oxide semi-conductors (CMOS) devices. In some cases, image sensors may be referred to as frame capture cameras. Also, in some cases, image sensors may be deployed or otherwise used as to collect event information.

As used herein the terms “trajectory,” “parametric trajectory,” “surface trajectory” refers to one or more data structures that store or represent parametric representations of curve segments that may correspond to surfaces sensed by one or more sensors. Trajectories may include one or more attributes/elements that correspond to constants or coefficients of segments of one-dimensional analytical curves in three-dimensional space. Trajectories for a surface may be determined based on fitting or associating one or more sensor events to known analytical curves. Sensor events that are inconsistent with the analytical curves may be considered noise or otherwise excluded from trajectories.

As used herein the term “configuration information” refers to information that may include rule-based policies, pattern matching, scripts (e.g., computer readable instructions), or the like, that may be provided from various sources, including, configuration files, databases, user input, built-in defaults, plug-ins, extensions, or the like, or combination thereof.

The following briefly describes embodiments of the innovations in order to provide a basic understanding of some aspects of the innovations. This brief description is not intended as an extensive overview. It is not intended to identify key or critical elements, or to delineate or otherwise narrow the scope. Its purpose is merely to present some concepts in a simplified form as a prelude to the more detailed description that is presented later.

Briefly stated, various embodiments are directed providing auxiliary devices for augmented reality. In one or more of the various embodiments, one or more images of a scene may be captured with one or more frame cameras included in a mobile computer.

In one or more of the various embodiments, a plurality of paths may be scanned across one or more objects in the scene with one or more beams provided by one or more scanning devices that are separate from the mobile computer.

In one or more of the various embodiments, a plurality of events may be determined based on detection of one or more beam reflections corresponding to the one or more objects such that the one or more beam reflections may be detected by the one or more scanning devices.

In one or more of the various embodiments, a plurality of trajectories may be determined based on the plurality of paths and the plurality of events such that each trajectory may be a parametric representation of a one-dimensional curve segment in a three-dimensional space.

In one or more of the various embodiments, the one or more images of the scene may be augmented based on the plurality of trajectories.

In one or more of the various embodiments, detecting the one or more beam reflections may include, detecting the one or more beam reflections by one or more event cameras included in the one or more scanning devices.

In one or more of the various embodiments, determining the plurality of trajectories may be based on one or more of triangulation, time-of-flight, or the like.

In one or more of the various embodiments, augmenting the one or more images of the scene may include: embedding one or more artificial objects in the scene based on the plurality of trajectories such that a position, an orientation, or a visibility of the one or more artificial objects in the scene may be based on the plurality of trajectories.

In one or more of the various embodiments, augmenting the one or more images of the scene may include: tracking a position of one or more eyes of a user using a front facing frame camera; embedding one or more artificial objects in the scene based on the plurality of trajectories and the position of the one or more eyes of the user; or the like.

In one or more of the various embodiments, the one or more scanning devices may include: a housing that may be either embedded or attached to one or more of a headband, an armband, a visor, a necklace, clothing, a chest harness, a belt buckle, a headgear, a hat, a mobile phone case, a notebook computer, a mobile phone, eyewear, or the like.

In one or more of the various embodiments, one or more of a power or a wavelength of the one or more beams may be varied based on one or more of a distance to the one or more objects, an ambient light condition, motion of the one or more scanning devices, motion of the one or more objects, power consumption, or the like.

In one or more of the various embodiments, capturing the one or more images of the scene may include: deactivating the one or more beam generators for one or more portions of the images such that the one or more portions may be captured absent interference by the one or more beams; employing the one or more portions to display the scene to a user; or the like.

In one or more of the various embodiments, one or more other images of the scene may be captured with one or more other frame cameras included in one or more other mobile computers. In some embodiments, a plurality of other paths may be scanned across the one or more objects in the scene with one or more other beams from one or more other scanning devices. In some embodiments, a plurality of other events may be determined based on the one or more beams and the one or more other beam reflections corresponding to the one or more objects and detected by the one or more other scanning devices. In some embodiments, a plurality of other trajectories may be determined based on the plurality of paths and the plurality of other events. In some embodiments, the scene may be augmented based on the plurality of trajectories and the plurality of other trajectories.

Accordingly, in one or more of the various embodiments, of a system for auxiliary device for augmented reality provides a mobile phone or other capture device with a camera, an accurate and timely (low-latency) description of the 3D surface geometries, including its six degrees of freedom (DoF) pose with respect to surfaces in view. Note, video as herein should be understood to include sequences of one or more image captured periodically or otherwise not limited to continuously stream of information or frames that conform to one or more video protocols or video codecs. Also, in some cases, video may be comprised of rapid bursts of single frame images that may be triggered by one or more external events, such as, motion detection, timers, user input, or the like. Accordingly, for brevity and clarity the term video is used herein to refer different types of captured or streaming imagery of a scene.

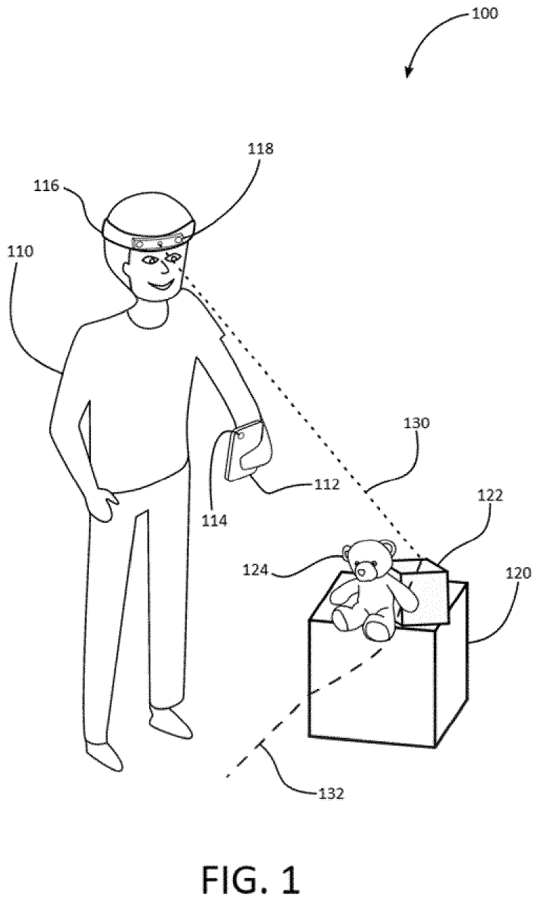

Accordingly, an example of a system for auxiliary device for augmented reality is shown in FIG. 1. In scene 100, user 110 may be considered to be holding a mobile phone, such as, mobile phone 112 that may include a rear-facing frame camera 114, though in some embodiments, mobile phone 112 may be replaced with a handheld gaming device, custom/purpose built hand-held computer, or other similar device that may provide a display screen and a camera. In some embodiments, rear-facing camera 114 may enable users to view video or images of the surrounding scene. In some embodiments, additional 3-D information may be provided by an illumination and scanning device such as illumination and scanning device 118, or the like, which may be mounted on a user's head using a headband such as headband 116. Also, in some embodiments, device 118 may be mounted using other attachment systems such as: a brim or visor of a hat or other headgear, worn around a user's neck on a chain, lanyard, or the like; attached to arms or legs by band or straps, embedded in clothing; or in other wearable configurations. In one or more embodiments, device 118 may be configured to attach onto glasses, sunglasses, goggles, or other eye wear or eye protection. In one or more embodiments, the scanning elements may be directly mounted in the frame of glasses, sunglasses, goggles, or other eye wear or eye protection that may be worn by a user. In one or more embodiments, the scanning device may be integrated into a mobile phone cases or other similar attachments for mobile devices. For example, in some embodiments, a device similar to device 118 may be integrated into a phone case for phone 112, or else might be clipped to the phone itself while using a suitable extension device with various attachment mechanisms.

In one or more of the various embodiments, the system may be used in an augmented reality (AR) mode. For example, for some embodiments, box 120 and box 121 may be present in the scene as viewed by a user via their mobile device, however an animated or static FIG. 124, in this example representing teddy bear, may be not actually physically present. In some embodiments, if viewed on the phone's screen, FIG. 124 may be virtually placed or embedded in the image such that it may appear to the user as being on top of box 120. Accordingly, in some embodiments, FIG. 124 may be placed such that it may appear to be sitting, standing, or otherwise moving on top of or in some relation to the real-world objects in the scene. Although only one FIG. 124 may be shown in this example, in some embodiments, multiple figures may be included in scenes. In some embodiments, scanning device 118 may be arranged to gather sufficient 3-D information about objects in its field of view by scanning a beam or beams 130 over object surfaces in the scene area and communicating with phone 112 about object data or positioning.

One example, for some embodiments, of a scanned trajectory across a surface in the scene may be path 132 which may trace over a portion of the boxes and the ground surfaces that may be around them in the scene. In some embodiments, because the system as a whole may be aware of the 3-D surfaces that may be visible to both scanning device 118 and phone camera 114, it may adjust positioning of the virtual objects in the scene. For example, for some embodiments, in FIG. 1, users would see FIG. 124 from the side, but if user 110 were to walk around to the front of the boxes shown in FIG. 1, obscured details of the boxes as well as FIG. 124 may then be displayed on the phone display from that changed perspective. In some embodiments, the visibility of objects may be updated as users may move around the scene.

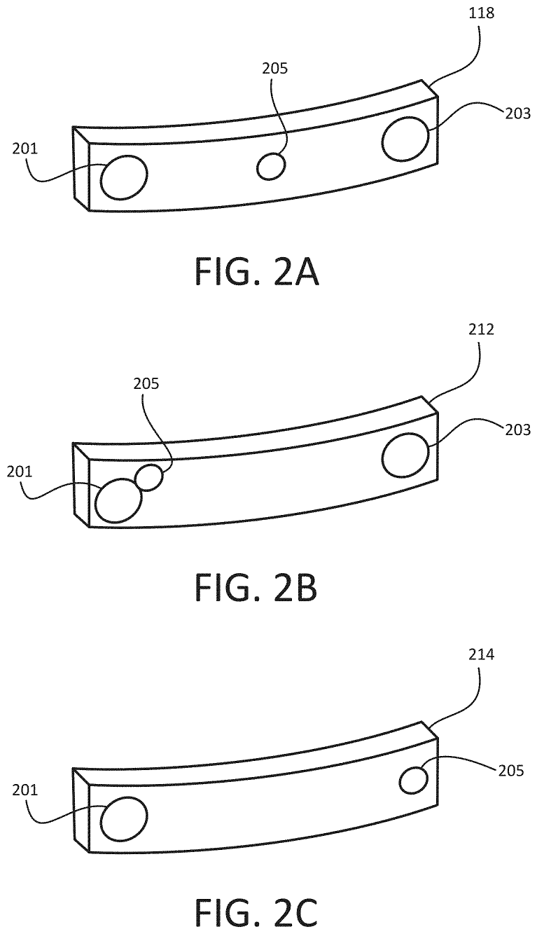

A close-up view of scanning device 118 may be shown in FIG. 2A in accordance with one or more of the various embodiments. In some embodiments, camera 201, camera 203, or the like, may be considered to be a type of event camera, which may have CMOS event image sensors, SPAD array sensors (sensors consisting of rastered arrays of pixels, where each pixel may be a single photon avalanche diode) or other devices where each pixel may asynchronously report timestamp information if a light level has changed past one or more threshold values; in some cases, for some embodiments, event cameras may positioned far enough away from each other to obtain enough disparity to measure 3-D objects. Also, for some embodiments, scanning device 118 may also include a laser beam scanner, such as, laser beam scanner 205 that may be arranged to continuously scan scenes over a prescribed field of view. In some embodiments, the laser scanner may output a single beam that may be scanned using MEMS mirrors or similar means. In some embodiments, the beam may be split by a diffractive optical element, or another type of beam splitter into a plurality of beams that may be configured to scan the scene. In some embodiments, path 132 may be an example of a scanned path, though typically this scanning may be very fast with thousands of scanned paths scanned per second depending on the scanning configuration. In some embodiments, the beam configured to trace a Lissajous or other similar pattern to blanket the scene over time. In some embodiments, event camera 201 and event camera 203 may be arranged to detect a series of events scattered or reflected from various surfaces at pixel positions in the image coordinate space of each event camera where each event may be associated with timestamp information with a time resolution based on the time resolution of the event camera, which may be 1 μs or faster. In some embodiments, events that may be detected in close proximity in both space and time may be grouped together and assigned as a continuous trajectory, which may be then fit with a time-parameterized curve function. Because the system may be well calibrated and characterized, the trajectories between the cameras with similar timestamps may then be used in triangulation to calculate the 3-D surface position of the curves in space relative to the event cameras and so also reveal the position of the surface of all objects traced over. (See, below for a detailed examples of how trajectories may be generated based on information captured by event cameras.)

Also, in some embodiments, scanning devices may be not measuring the surfaces in the scene directly, in some cases, for some embodiments, scanning devices may be arranged to measure the 3-D mesh of scanning trajectories that it projects onto the surfaces of objects in the scene. Accordingly, in some embodiments, if camera 114 also detects the same 3-D mesh, the positions of scanning device 118, camera 114, as well as the objects in the scene may be detected relative to each other at that time, and those positions may continue to be tracked over time as these three elements move. In some embodiments, the projected 3-D mesh may be sparse, but this may be sufficient to localize all objects or cameras for each frame of the video. Accordingly, in some embodiments, this may lower the overall power used by the system on either or both of scanning device 118 and camera 114. In some cases, for some embodiments, the projected 3-D mesh may be denser, but may only need to transmit only a portion of the information about key positions or crossing points on object in the scene to adequately localize these positions.

FIG. 2A shows scanning device 118 for auxiliary device for augmented reality in accordance with one or more of the various embodiments. In this example, for some embodiments the scanner may be placed between two cameras. In one or more embodiments, a scanning device, such as, scanning device 212 may be arranged to have similar elements (two event cameras and a beam scanner), but the position of beam scanner 205 may be arranged to be near to one event camera, such as, camera 201 such that the event camera and beam scanner may be considered substantially co-located as shown in FIG. 2B.

FIG. 2C shows one other variant for auxiliary device for augmented reality in accordance with one or more of the various embodiments. In some embodiments, scanning device 214 may be arranged to have one event camera 201, with beam scanner 205 positioned to the far side of scanning device 214. In some embodiments, event cameras provide event low latency and may report events associated with particular pixels asynchronously. In contrast, in some embodiments, cameras 114 on a mobile phone, such as, mobile phone 112 or other device may usually be comprised of frame capture cameras, where light may be collected and integrated over time to produce an image, and in some cases, some or all of these images may be captured as a series of discrete image frames to make to comprise video stream or video signal. Accordingly, in some embodiments, in some cases, a detailed timestamps for generating accurate curve trajectories may be difficult to determine from frame capture video signals/streams. For example, for some embodiments, if a frame camera may be capturing frames at 60 Hz, video data or trajectories that come into its view may only be localized in time to a ˜16 ms window. However, in some embodiments, frame capture cameras may be used to capture a video signal the integrate the beam traces to capture the paths of the scanned laser trajectories as they are scanned across surfaces in the scene.

In some embodiments, beam scanner 205 may be arranged to employ lasers with center wavelengths on or around 405 nm, or the like. Accordingly, for example, for some embodiments, at low power (around 1 mW or less) these wavelengths may be barely visible to the human eye while still readily detected by typical phone frame cameras even with interference from ambient light such as sunlight. Also, in some embodiments, the wavelength may be easily detectable under some or all indoor lighting conditions especially indoor lighting that uses LED lighting which often has little radiant power at 405 nm. Accordingly, in some embodiments, laser light with wavelengths around 405 nm may be captured by phone frame cameras, such as, phone frame camera 114 despite various color filters that may be employed in the frame camera image sensors. Also, in some embodiments, narrow-band filters may be employed on event cameras to reject some or all ambient light. Thus, in some embodiments, scanning devices disclosed herein may be employed indoors or outdoors. Also, in some embodiments, other wavelengths may be used for scanning. For example, in some embodiments, lasers for scanning may be arranged to employ light wavelengths that may match one or more color filters used in frame camera 114, or the like.

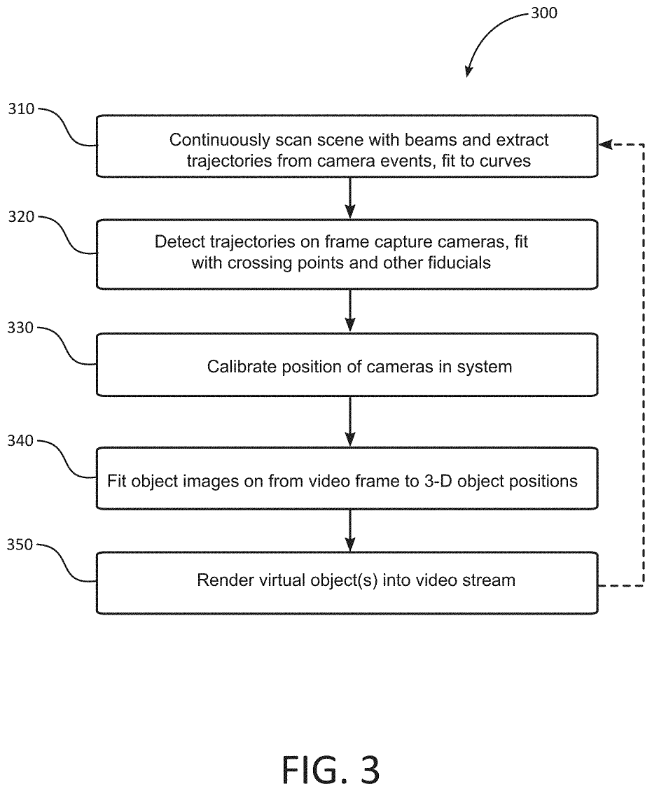

FIG. 3 illustrate an overview flowchart for a process for employing auxiliary devices for augmented reality in accordance with one or more of the various embodiments.

In step 310, in some embodiments, the beam scanner may be arranged to continuously scan the scene with one or more beams. Accordingly, in some embodiments, as each beam crosses over and leaves an object, events may be captured at event camera 201 and event camera 203, and a corresponding time-parameterized function may be fit to the event position and timestamp data to create a plurality of trajectories associated with scanned objects or other surfaces that may be in the scanned scene. In some embodiments, trajectories may be matched between the event camera cameras and then triangulated along the entire curve to generate a 3-D curve in space representing that may correspond to the surface of scanned objects.

In some embodiments, one or more illumination beam sources may scan the scene using independent scan patterns. In some embodiments, the event cameras may discern and match individual trajectories between themselves and to assign 3-D curves to all trajectories. In some embodiments, event cameras may have sufficient time resolution to act as time-of-flight (ToF) cameras, which might directly extract 3-D information about trajectories using ToF and beam angle tracking.

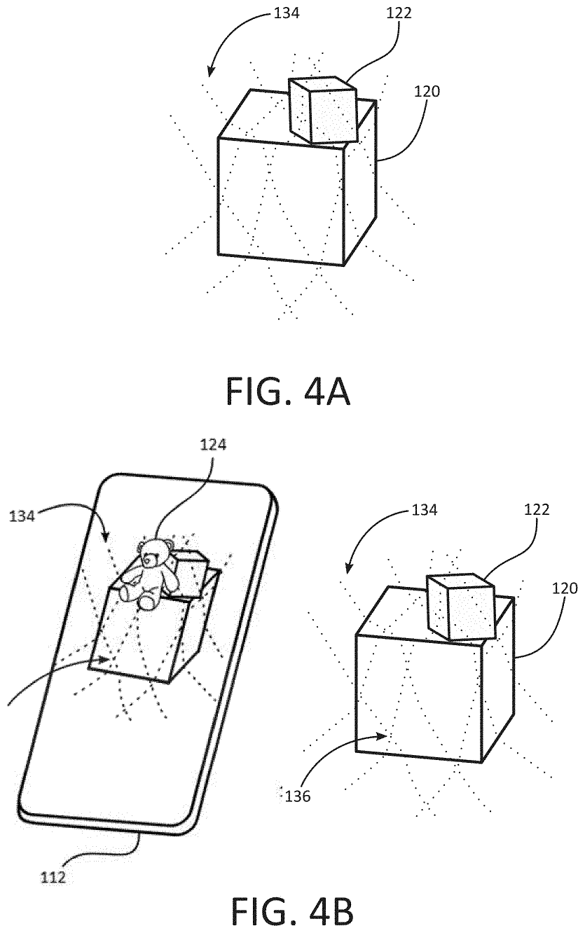

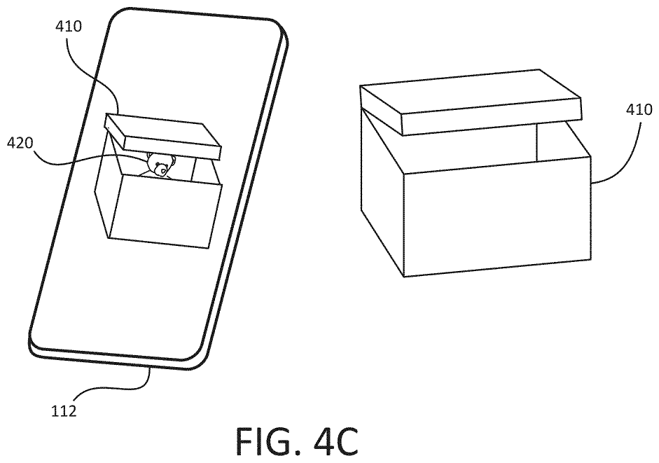

FIG. 4A shows a portion of scene 100 from FIG. 1, where a number of scan paths, collectively 134, may be shown over two boxes in the scene. Accordingly, in some embodiments, scan paths 134 may be based on several successive scans over a particular time period or time window. In this example, FIG. 4A shows the scan paths 134 from one perspective, but each event camera may have a different/separate perspective based on its particular position on the scanning device or relative the scene. Although the beam paths may appear relatively continuous from the direction of the laser itself, one or more discontinuities may be in the field of the event cameras or frame cameras such that the paths may appear to jump from between surfaces, objects, or background objects, or the like. Accordingly, in some embodiments, trajectories may be started or ended based on detected edges associated with transitions between objects or surfaces in the scene.

In step 320, in one or more of the various embodiments, some or all of the trajectories determined based on event cameras may be detected on phone frame camera 114. In some embodiments, other than noise, most of the events reported from the event cameras may be reflected beam signals. This may be less true for the phone frame camera, which has scanned beams superimposed on the scene picture at each frame.

In some embodiments, if frame camera may be arranged to operate with a frame capture rate of 30 Hz to 60 Hz, or the like, the scanning rate of beam scanners may be configured such that that there may be many scans in each frame captured by the frame cameras. Further, in some embodiments, scanning rate may be varied or modulated depending on current lighting conditions or other environmental conditions. In some embodiments, sufficient number of trajectories may be detected to characterize the 3-D surface position with respect to phone camera 114, but in some cases too many scan lines in the frame may be disadvantageous for identification and matching of trajectories. Accordingly, in some embodiments, known or dynamically determined fiducial points augment determining the identity of each trajectory. For example, in some embodiments, discontinuities in the trajectories that indicate edges of an object may be deemed crossing points. Accordingly, in some embodiments, discontinuities that may be in field of view of event cameras may be detected if the timestamp of events continues increasing smoothly as the scan progresses, but the (x, y) position values associated with events in the event stream abruptly change or jump. Accordingly, in some cases, these jumps in position may also be detected on phone frame camera 114 as well, so the endpoints of trajectories measured on event cameras, such as, event camera 201 or event camera 203 may be associated with similar positioned trajectory information captured by on frame cameras. Similarly, in some embodiments, positions on objects or surfaces where scan paths or trajectories are determined to cross each may employed fiducial points for associating trajectories with particular objects, surfaces, or the like.

FIG. 4B shows the same portion of the scene as FIG. 4A, but additionally includes an image as seen from the perspective of mobile phone 112. In some embodiments, mobile phone 112 may detect the set of beams 134 in its frame camera 114. In this example, for some embodiments, some of the trajectories may appear to cross on the image; one example may be crossing point 136.

In some embodiments, crossing points of beams may or may not happen simultaneously or in some cases, simultaneous crossing of scan beams may be unlikely. Accordingly, in some embodiments, crossing points may be associated with different beams at different times or may also be the same beam crossing itself during the scanning. In some embodiments, the crossing points may have parameters in the form of (x, y, t₁, t₂), where (x, y) may be the position of the crossing point in the image coordinate space of the event camera, t₁ may be the timestamp if the first trajectory crosses that point, and t₂ may be the timestamp if the second trajectory crosses that point. In some embodiments, trajectories may be matched between event cameras by comparing timestamps of crossing points between the event cameras; although crossing points may occur at different positions on each event camera, the apparent crossing points may happen at the same time one or more event cameras. In some embodiments, the crossing points associated with frame cameras may have the form (x, y) since the exact timing may be unknown. Accordingly, in some embodiments, the overall shape and positioning of the trajectories visible in the frame of the phone frame camera may be matched to trajectories captured by the event cameras within the same time window as the frame of the phone frame camera was captured. Accordingly, relative number and positioning of crossing points may assist with this. In some embodiments, if the trajectories may be identified, the trajectories detected via the frame capture camera may be fit to spatial functions, and the (x, y) crossing points may be calculated for the images/video captured by frame camera 114. In other embodiments, the scan rate may be fixed, but the duty cycle of the scanning laser may be varied; in this case, the laser may be modulated such that fewer lines may be scanned on portions of the scene where frame camera 114 does not detect up lines from the scan. In some cases, for some embodiments, this may occur if objects in the scene may be too far away, or if there may be gaps fields of views of the various (event or frame) cameras such that the field of views have partial overlap. Accordingly, in some embodiments, providing/using more photons on close objects detected by the event camera, power use of the scanning device may be reduced while at the same time providing fewer trajectories for phone 112 and frame camera 114 to differentiate; this may enable the system to focus on relevant objects and simplify the matching of scanned lines or trajectories. Also, in some embodiments, if frame camera 114 and the scanning device may be enabled to communicate with each, the camera may also provide feedback to scanning device 118 regarding if there may be sufficient scan lines to cover the objects in the scene absent ambiguity. In some embodiments, modulation of the scanning beams may not be strictly digital but may also be analog as well. For example, in some embodiments, certain parts of the scan, the laser power may be raised to improve contrast on the object or lowered if the scanned line does not need extra brightness at certain locations. Further, in some embodiments, the scan patterns may be dynamically adjusted over time to improve the coverage of objects in a scene.

In step 330, in some embodiments, systems may be calibrated based on the relative positions and orientations of the cameras. For example, a system that includes a device such as device 118, the two event cameras may already be well-calibrated with respect to each other in position and orientation. Nevertheless, in some embodiments, this calibration may be fine-tuned using crossing points and trajectory position information. Also, in some embodiments, the set of trajectories captured by frame capture camera 114 may be examined and matched to trajectories determined from the event cameras. In some embodiments, the position and orientation of the frame may be determined relative to event cameras using bundle adjustments or other methods (such as fitting the various crossing points alone). In one or more embodiments, the position of frame camera 114 and the rest of the phone may be fine-tuned using data from other frame cameras on the phone. For example, many mobile phones also have a front-facing camera that may be facing the user. Accordingly, in some embodiments, front-facing cameras (not shown in the figure) may be active to view the position of the face of the user and also the position or orientation of scanning device 118 with respect to the front-facing camera. In some embodiments, device 118 may see the position of phone 114 and update its knowledge of the phone with respect to the device directly.

In some embodiments, this data may be used for other functions as well. For instance, in some embodiments, front-facing cameras may be configured to track the gaze direction of the user's eyes which may be employed control or modify the actions or position of the virtual figures that may be embedded into the scene. In some embodiments, scanning device 118 or mobile phone 112 may be in communication which may enable locations of important points in the scene to be shared. For instance, scanning device 118 may only transmit 3-D crossing point locations or else may communicate full details of the time-parameterized functions of scanned trajectories measured from the surfaces of objects. In some embodiments, such communication may be enabled using wireless means such as Bluetooth or Wi-Fi, but in some cases, if a front-facing camera on the phone may observe scanning device 118, the scanning device may use LEDs or other optical signaling methods to transmit various information to between the phone or the scanning device.

In step 340, in some embodiments, positions of objects in the scene of camera 114 may be determined. Accordingly, in some embodiments, trajectories in camera 114 view may also be fit to the positions of the objects. In some embodiments, this may be done by using the trajectories directly on the surface. In an embodiment, the 3-D positions of objects in relation to camera 114 may be built up and measured over time to characterize the camera field of view, lens distortions and aberrations, or other parameters associated the phone or frame camera 114. In some embodiments, if this has been done, it may be possible to predict where a 3-D object should appear on frame camera 114 based on knowledge of where camera 114 may be relative to event camera 201 or event camera 203 at any snapshot in time. In this case, in some embodiments, the trajectory data on the objects may indirectly be used to determine 3-D positions; here the positions of the 3-D objects may be determined from the scanning device 118, while the trajectory data from the frame camera may be used to localize its position.

In step 350, in some embodiments, virtual figures may be inserted into the video provided by frame camera 114. It may be possible that the video may be treated as a 2-D flattened view with additional 2-D figures (e.g, sprites) overlaid, however in some embodiments, the figures may be 3-D models themselves. In some embodiments, the 3-D position of objects in the scene and where they appear on the image sensor of frame camera 114 for each frame may be used to position figures precisely or dynamically. An example of this may be seen in FIG. 4B, where in the real world, box 121 and box 122 only show scan lines, in the camera image space, FIG. 124 may be placed among the objects. From the image view on the mobile phone, it appears that virtual objects are placed in relation directly to the objects, but in some embodiments, the positioning of the virtual objects is placed relative to the scanned paths 134, which also might be referred to as a mesh scaffolding around real world objects. Calculating with respect to the mesh scaffolding may allow virtual object placement with less computation, as well as make the system more responsive to user movement, object movement, or both. In some embodiments, while this may be represented in 2-D on the screen of mobile phone 112, the representation may be still in 3-D. For example, in some embodiments, if the user were to walk around the boxes, FIG. 124 may be partially occluded by that viewpoint. Furthermore, objects in movement with respect to a frame capture camera (whether the camera or the object may be moving) may appear to have some motion blur. Because the event camera data may capture movement much faster than the frame rate of most frame capture cameras used, in some embodiments the video may be rendered to improve the appearance of actual objects in the scene. In other embodiments, virtual objects may be rendered so that their apparent motion blur may match that of other captured objects. In other embodiments, the calculated position of the frame camera 114 as it moves can be used to adjust the perspective of the 2-D video as well as virtual objects in the scene. For example, the perspective on the screen may be adjusted to more properly show the 2-D video as seen from the viewer's eye position. This may work even if front-facing cameras are not used to locate the user's eyes or the event-capture 201 or 203 positions, as positioning data is continually recalculated as the camera systems move with respect to one another; in some cases, if mounted on a headband, this could be a reasonably proxy for a user's eye position and perspective view. The 2-D video may be dynamically altered with less computation needed than pure image processing methods because objects in the scene that comprise the 2-D video have known 3-D positions.

In some embodiments, measurements/dimensions of objects in the scene may dynamically alter virtual figures in the scene as well. FIG. 4C shows an example where chest 410 has been partially opened. Accordingly, in this example, before chest 410 was opened by a user, chest 410 may have appeared to the system as a box where objects may be positioned in relation to the outside of the box. Accordingly, if chest 410 may be opened partially, the scanning device may detect that there was an internal cavity inside chest 410. Accordingly, in an application, virtual FIG. 420 may be drawn in the video on mobile phone 112 to “pop out” and surprise the user.

In some embodiments, there may be only one event camera in the system such as scanning device 214. Accordingly, in one or more embodiments, laser scanner 205 may be arranged to include feedback circuitry to track the position of the output beam over time. Accordingly, in some embodiments, if the feedback circuitry may be accurate enough, triangulation may be performed at event camera 201 since the position of the scanner may also be well-calibrated with respect to the event camera. In this case, for some embodiments, absolute accuracy of the 3-D positions may be less than that of a device with two or more event cameras, but this may still be sufficient to localize the positions of 3-D objects scanned well enough to determine the position of frame capture camera 114 on the phone. In some embodiments, a single event camera with feedback circuitry for angular position may be combined with ToF measurements at a sensor to provide 3-D information about the objects. In another embodiment, even if the laser scanner has no position feedback, this may still be useful for insertion of 3-D models into the video streams. In some embodiments, event cameras may be configured measure relative positions of crossing points or other artificial fiducials on the objects. Though, in some embodiments, the precise 3-D position of objects in the scene may not be known, artificial fiducials may be used as surface markers as visible from frame camera 114 to place figures or other virtual objects into the video stream. In some embodiments, a separate type of scanner may be used instead. For instance, in some embodiments, a simple type of projector, perhaps one that projects a fixed or changing structured pattern may generate artificial fiducial points on objects that may be advantageous for making surface markers to localize positions to place virtual figures into the video. In some cases, for some embodiments, the projector may be a laser with a diffractive optical element.

In some embodiments, a potential issue with this arrangement may be visibility of the lines in the camera image. Accordingly, in some embodiments, if the laser were scanning using a wavelength of 405 nm at relatively low power, the laser on the objects in the scene may be barely visible or not visible at all to the human eye while it may be clearly visible in the video stream. Accordingly, in some embodiments, if the video stream is provided to users unadjusted, this may lead to observable artifacts in the video as shown to users. For example, the phone image in FIG. 4B shows virtual FIG. 124 as added to the video stream, and also displays various scan paths 134. Thus, in some cases, for some embodiments, it may be advantageous to remove artifacts that may be associated with the scan paths from the video stream. In one or more embodiments, after the scan beams 134 may be detected and used to localize the phone and other objects, various image processing operations may be employed to remove some or all of the scan beam related artifacts. For example, in some embodiments, the spectral response of the pixels of frame cameras may be known which may enable them to be removed through image manipulation. In some embodiments, because the scan pattern may be designed to fill the scene over time, the observed beam pattern may appear semi-random in a short time scale, such that details of other objects in the scene as well as one or more portions of the background of the scene may be detected earlier in other frames and used to replace the portions with scan lines overlaid. In some embodiments, pixels along the identified trajectories may be replaced directly by equivalent ones from other frames but may also be camouflaged by blending intensities with neighboring pixels near the trajectory, also known as “inpainting”.

In some embodiments, removal of scan patterns may be unnecessary, since only a portion of the video frames may be used for direct display. In some embodiments, camera 114 may be configured to operate at a higher frame rate than needed in the output video stream, and in some frames, the laser scanner may be turned off so its beams may not interfere with the video. In some embodiments, because movement in the frame may be either slow compared to the frame rate, or may be behaving relatively predictably from frame to frame, 3-D data and positioning information may be sufficient to localize objects in between frames. Although, in some embodiments, the interleaving of video with scan lines and video without scan lines may be consistent, in some variants, the interleaving rate may be variable if conditions change (e.g., if fast-moving objects appear in the scene, more time may be taken for scanning with the laser compared to if the scene may be relatively static). In some cases, in some embodiments, other secondary inputs may be used to assist in determining the orientation of the phone if fewer frames may be used to measure scan lines; this may include data from the front-facing camera but may also use secondary sources such as acceleration or rotation from the inertial measurement unit (IMU) on the phone.

In some embodiments, scan patterns may be visible from some frame capture cameras in the system. Although the systems herein may be described as including a mobile phone with only a single frame such as frame camera 114, some phones may have two or more cameras that may be configured to capture a scene with different fields of view, different zoom levels, or the like. For example, in some embodiments, two frame cameras may be used to capture the scene simultaneously, but with frame rates of each frame camera out of phase with each other such that one of the frame cameras does not capture one or more portions of the scene while beams may be scanned onto the scene. In one or more embodiments, a filter, such as, for example a notch filter that removes 405 nm light from the image may be affixed to the front of the lens of one of the rear-facing cameras; since most light captured by the cameras for standard frame captures do not capture much light at this wavelength, a filter like this one may have little effect on camera and video taken by other applications. In this case, for some embodiments, one frame camera may capture the video with visible scan lines for precise localization of objects with respect to the mobile phone, and another frame camera with a relevant filter may be used to generate the video signal used displaying embedded objects. In this case, the two or more frame capture cameras used may need to be well-calibrated so that images of real-world objects and virtual figures overlap precisely, but this may be often done already in the camera if digitally compositing portions of images from multiple cameras. In some embodiments, digital composition may be readily accomplished using image processing techniques built into the frame camera software on the mobile device, but in some cases, this may be done more efficiently and accurately with additional knowledge of the position of objects as reported by some embodiments to the system. Also, in some embodiments, a narrow band-pass filter may be used instead of a notch filter on one of the cameras at the scanned beam wavelength. In some embodiments, the frame camera with the band-pass filter may be arranged to detect scanned lines from the scan beams rather than other elements of the scene making detection of the 3-D scanned line mesh unambiguous and allowing localization of the phone position with less computation and power. In some embodiments, one or more methods may be used simultaneously (e.g., one rear-facing camera has a notch filter and another a band-pass filter at the scanned wavelengths).

In one or more of the various embodiments, if a video frame has been adjusted, the process may loop back to step 310. The process may continue until the application controlling the additions of virtual objects and figures into the video stream is terminated or suspended.

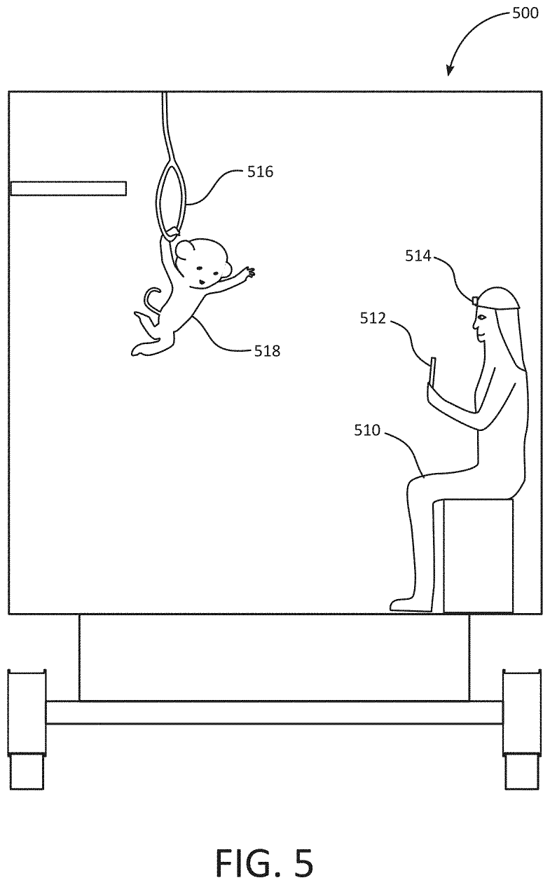

In some embodiments, the IMU may be used to improve positioning data of the mobile device, but in some circumstances if the user and the scene may be moving, this may not be sufficiently reliable. One example may be illustrated in FIG. 5, which shows a cross section of train car 500. In this example, for some embodiments, user 510 may be holding phone 512 and wearing scanning device 514 to supplement 3-D measurements of objects inside the train. Although, in this example, the IMU in phone 512 may detect movement of the phone within train car 500, additional movements and accelerations of the vehicle itself may be also detected that cannot be easily separated out from internal movements directly. For example, strap 516 hanging from the ceiling of train car 500 may be moving as the train turns or accelerates, but also because sharp movements may make both the strap as well as other objects move abruptly. Additionally, in some cases, one or more physical properties of the strap may make it move unpredictably even if more accurate information about acceleration was available. However, in some embodiments, the 3-D measurements of scanning device 514 combined with data from phone 512 camera may be used using mostly optical means to localize the position of the phone relative to other objects or people in the scene. Thus, for example, virtual figures such as monkey 518 may be placed in the video stream on the phone regardless of other quick movements of both objects in the scene as well as phone 512 or scanning device 514. In some embodiments, calibration of positions may be fast enough to substantially be done every frame so that the position of virtual figures may be consistent or smooth. For example, because the 3-D model position of strap 516 may be updated quickly, even if it may be swinging back and forth. Movement of the objects may appear as the phone may be moving in a user's unsteady hands. However, virtual monkey 518 may be still apparently be hanging from the real object with enough detail to show the monkey's hand gripping the strap, since to the 3-D scanning portion, the projected mesh remains clear and unblurred. This may be done because the instantaneous 3-D positions and velocity of the strap with respect to the phone camera may be known at each snapshot frame of the phone based on the projected 3-D trajectories detected on the strap.

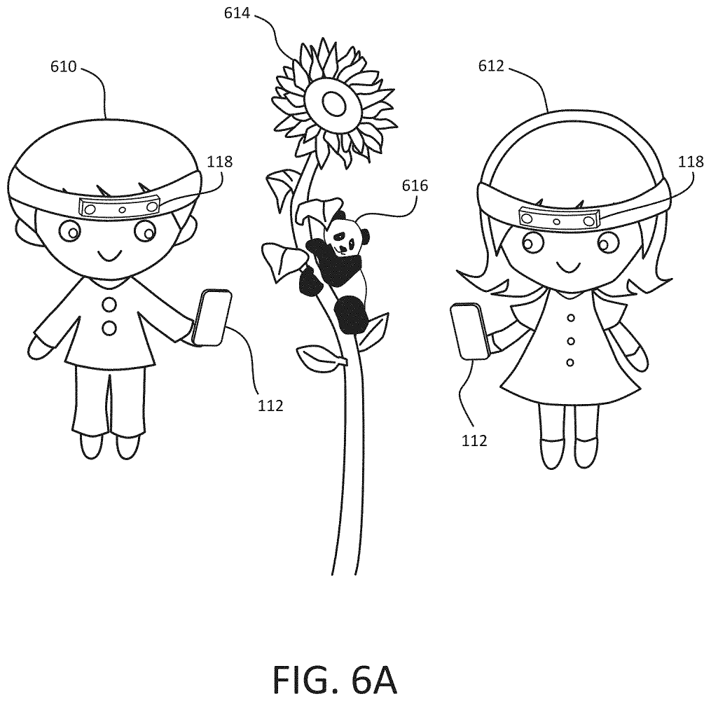

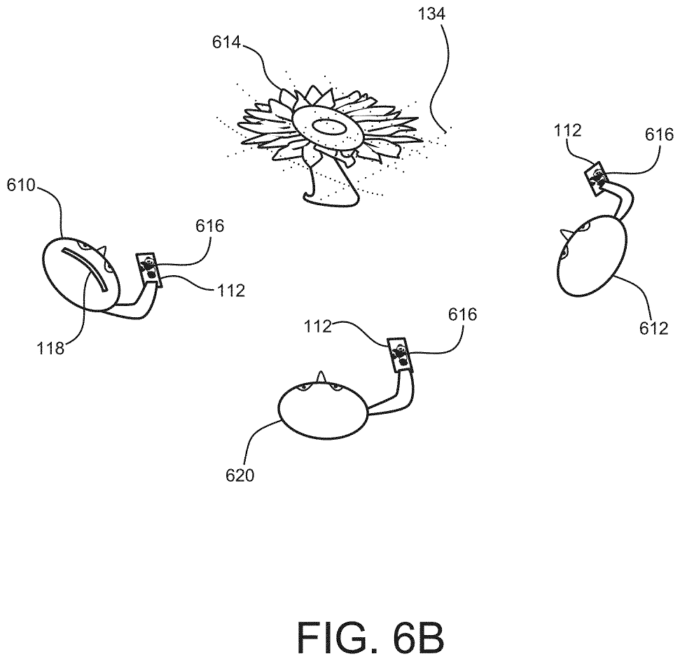

In some embodiments, more than one scanning device may be used collaboratively. In some embodiments, if using a scanning device such as device 118, another similar device scanning the same object simply adds more scanning lines to the scene that may be detected by event cameras and provide more dense information about a scene. This may be illustrated in FIG. 6A where two users may be both looking at the same object. In this example, the users may be observing an object, such as, sunflower 614 that may exist in the real world. In an example, two users, such as, user 610 and user 612 may be each wearing a scanning device, such as, scanning device 118. Accordingly, in some embodiments, scanning devices similar as described above may be worn by each user on a headband, a visor, or at some other mounting point on their person. Accordingly, in this example, each user may be also pointing mobile phone 112 at the same object, sunflower 614. Also, in this example, they may be running instances of the same application on each of their phones, which may show a virtual figure, panda 616 climbing the sunflower. In this example, FIG. 616 may be shown on the in the scene moving around the features of sunflower 614 in a realistic manner and moving with the sunflower as it blows in the wind or otherwise moves. In some embodiments, each user may be projecting scan lines on the object and the rest of the scene, and on their phone display screen may show the scene that includes virtual FIG. 616 climbing up sunflower 610 from their own vantage point. In some cases, scan lines associated with both users may be tracked on each scanning device and may also be seen from the phone cameras.

In some embodiments, if a world object has been assigned to a fixed position with a modeled shape, users may move around the object without losing track of that object; even if one user moves around the world object in such a way that projected scan lines from user 610 may be not seen by either scanning device 118 or phone 112 camera of other user 612, the two applications may be arranged to communicate shape, positioning, or other information about objects scanned to continually update positions of world objects as well as other users' positions relative to each other. In some embodiments, the 3-D surface of the model may be retained in the application even as one or more users move around the object; since the model is retained, it can be used to position virtual figures in positions even though the user may have moved so that there are not currently scanning lines on that portion of a world object. Because a world object may be continually scanned and at least a portion of its position tracked, those other portions of the world object not being scanned can be calculated precisely as well. In some embodiments, users may see the same virtual FIG. 616 or different figures depending on the configuration of their applications. In some embodiments, the applications may be in communication between the phones, enabling the movements of the figure to be synchronized between the applications. In some embodiments, the applications may also communicate crossing points or other information about one or more scanned trajectories in 3-D space. In other embodiments, scanning devices 118 may be in communication with each other directly.

In one or more embodiments, in some cases, users may have their video applications from their cameras zoomed out to a similar field of view as each other, but alternately one or more of them may also zoom in their cameras to see magnifications of the scene; here zoomed in versions of other virtual figures or other objects may be displayed. In some cases, enough detailed information of the real-world objects may be taken to enable the applications to augment the magnified view of the objects themselves. In some cases, the scanning of real-world objects may be detailed enough so that it may be captured and added into the application as a new object to be displayed at another time. The application used for augmented reality collaboration may also provide interactive features to facilitate this. In some embodiments, virtual figures 616 may be placed realistically on real world objects but may also move around to encourage the users to capture fine details about the surface of objects 614. In some cases, users may be playing an augmented reality game where the application gives a reward if an object, such as, object 614 may be captured in sufficient detail. In some cases, one or more virtual object or figures may be displayed as moving or flying to other real-world objects in their vicinity to encourage the users to follow and scan these other real-world objects. Although this may be done to improve the game or other experiences of users, the application may also use this data for secondary purposes. In one or more embodiments, it may be the purpose of the application to constantly capture data about real-world objects; full scanned data of the 3-D surface of an object model as well as its world location may be sent to centralized servers running the application. In other cases, location information may not be needed by the application, but instead varieties of models captured. For example, in some embodiments, the application may give a goal to a user to find virtual figures on ten different flowers to build up a database of various flower appearance match with an accurate 3-D model.

In one or more embodiments, a third user 620 may approach the other two users, and even if the third user 620 does not have scanning device 118, the camera on their phone may still view the scanned trajectories broadcast by those of the other users. This is illustrated in FIG. 6B, which shows an overhead view of the same or similar scene as shown in FIG. 6A. In this case, by communicating details of the crossing points and other features to the first two user's phone application, the third user's application may localize its own position relative to 3-D model data about world objects such as sunflower 614. In this case, the third user may see the same virtual objects 616 projected onto the video stream with similar accuracy to the other two users or may instead use the knowledge of exact positioning of world objects to display its own virtual figures or objects. If the other two users 610 and 612 may be scanning the scene from disparate angles, significant coverage of the object may result, and the third user may be able to view virtual figures on the object from most any angle. Similarly, in one or more embodiments, in the case where two or more users, such as, users 610, 612, and 620 may be viewing the scene where only user 610 has a scanning device, such as, scanning device 118, the other users such as users 612 and 620 may still be able to view virtual figures on their phone based on information communicated to them regarding the position of their phone as well as details of the position of the 3-D scan line mesh. Similar as before, if a single user 610 with the scanner moves around an object 614, a detailed 3-D model can be built up internally within the application. This model may be used to provide views of the object and virtual objects to other users without a scanning device correct to each other user's perspective. Virtual objects may be superimposed on the phone screens even on portions of the object 614 that are not currently being scanned with a 3-D scan line mesh as long as the frame cameras of the other users can see at least a portion of the scan line mesh sufficient to localize the position of the object 614 with respect to the phone camera. In some embodiments, this may continue to occur dynamically even as user 610 moves or the sunflower 614 moves. For example, if the wind blows leaves of the sunflower 614, if the virtual object 616 was placed on a moving leaf, because the scan line mesh moves and tracks the leaf position at each instant, the virtual object could track with the moving leaf seamlessly from the perspective of each user's phone camera.

### Illustrated Operating Environment

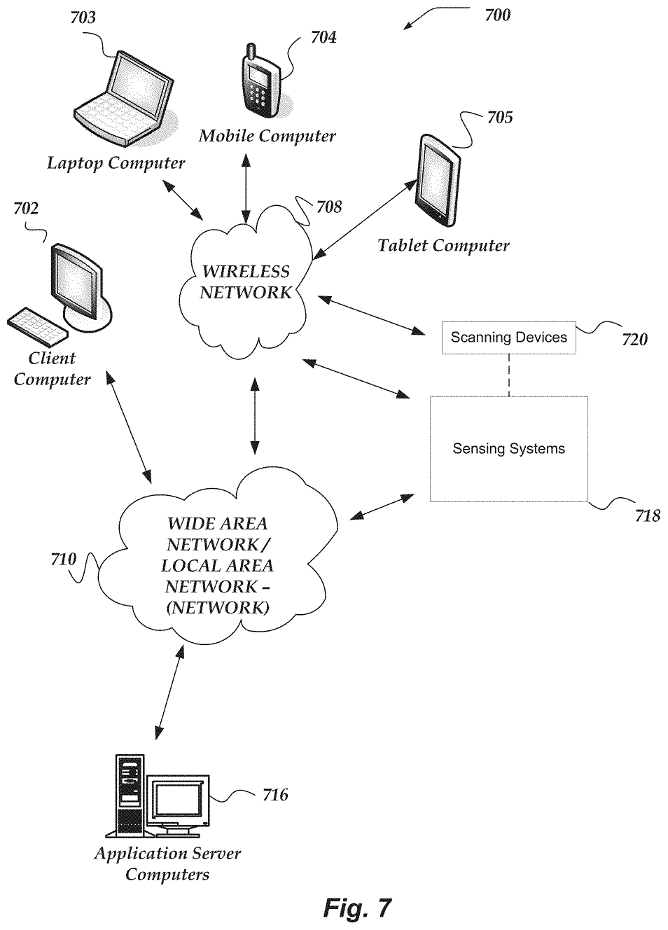

FIG. 7 shows components of one embodiment of an environment in which embodiments of the innovations may be practiced. Not all of the components may be required to practice the innovations, and variations in the arrangement and type of the components may be made without departing from the spirit or scope of the innovations. As shown, system 700 of FIG. 7 includes local area networks (LANs)/wide area networks (WANs), such as, network 710, wireless network 708, client computers 702-705, application server computer 716, sensing systems 718, scanning devices 720, or the like.

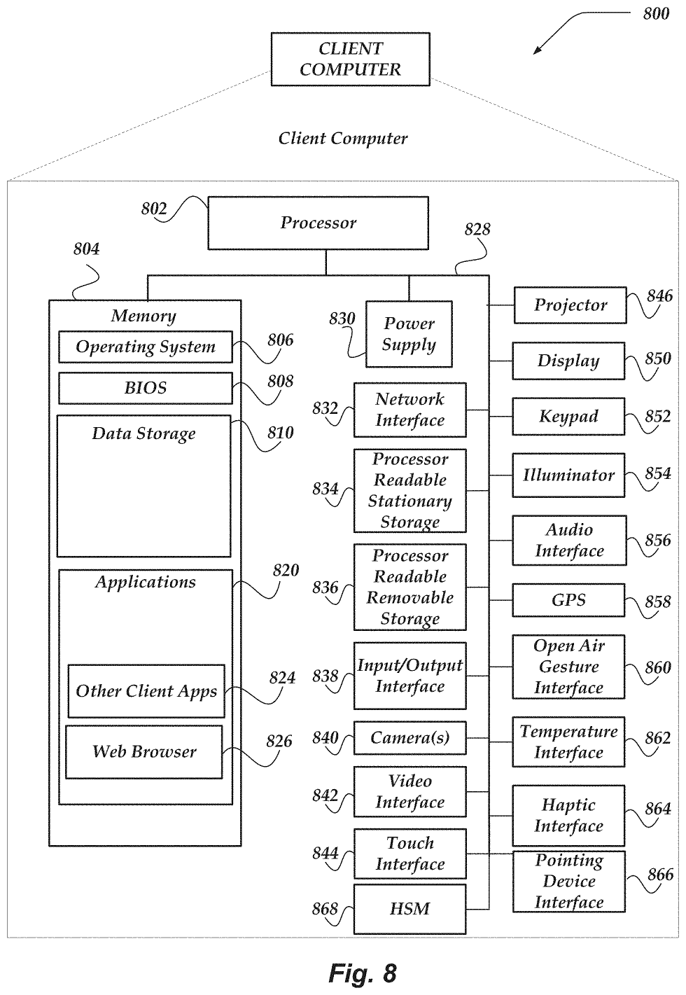

At least one embodiment of client computers 702-705 is described in more detail below in conjunction with FIG. 8. In one or more embodiments, at least some of client computers 702-705 may operate over one or more wired or wireless networks, such as networks 708, or 710. Generally, client computers 702-705 may include virtually any computer capable of communicating over a network to send and receive information, perform various online activities, offline actions, or the like. In one embodiment, one or more of client computers 702-705 may be configured to operate within a business or other entity to perform a variety of services for the business or other entity. For example, client computers 702-705 may be configured to operate as a web server, firewall, client application, media player, mobile telephone, game console, desktop computer, or the like. However, client computers 702-705 are not constrained to these services and may also be employed, for example, as for end-user computing in other embodiments. It should be recognized that more or less client computers (as shown in FIG. 7) may be included within a system such as described herein, and embodiments are therefore not constrained by the number or type of client computers employed.

Computers that may operate as client computer 702 may include computers that typically connect using a wired or wireless communications medium such as personal computers, multiprocessor systems, microprocessor-based or programmable electronic devices, network PCs, or the like. In some embodiments, client computers 702-705 may include virtually any portable computer capable of connecting to another computer and receiving information such as, laptop computer 703, mobile computer 704, tablet computers 705, or the like. However, portable computers are not so limited and may also include other portable computers such as cellular telephones, display pagers, radio frequency (RF) devices, infrared (IR) devices, Personal Digital Assistants (PDAs), handheld computers, wearable computers, integrated devices combining one or more of the preceding computers, or the like. As such, client computers 702-705 typically range widely in terms of capabilities and features. Moreover, client computers 702-705 may access various computing applications, including a browser, or other web-based application.

A web-enabled client computer may include a browser application that is configured to send requests and receive responses over the web. The browser application may be configured to receive and display graphics, text, multimedia, and the like, employing virtually any web-based language. In one or more embodiments, the browser application is enabled to employ JavaScript, HyperText Markup Language (HTML), eXtensible Markup Language (XML), JavaScript Object Notation (JSON), Cascading Style Sheets (CSS), or the like, or combination thereof, to display and send a message. In one or more embodiments, a user of the client computer may employ the browser application to perform various activities over a network (online). However, another application may also be used to perform various online activities.

Client computers 702-705 also may include at least one other client application that is configured to receive or send content between another computer. The client application may include a capability to send or receive content, or the like. The client application may further provide information that identifies itself, including a type, capability, name, and the like. In one or more embodiments, client computers 702-705 may uniquely identify themselves through any of a variety of mechanisms, including an Internet Protocol (IP) address, a phone number, Mobile Identification Number (MIN), an electronic serial number (ESN), a client certificate, or other device identifier. Such information may be provided in one or more network packets, or the like, sent between other client computers, application server computer 716, sensing systems 718, scanning devices 720, or other computers.

Client computers 702-705 may further be configured to include a client application that enables an end-user to log into an end-user account that may be managed by another computer, such as application server computer 716, sensing systems 718, scanning devices 720, or the like. Such an end-user account, in one non-limiting example, may be configured to enable the end-user to manage one or more online activities, including in one non-limiting example, project management, software development, system administration, configuration management, search activities, social networking activities, browse various websites, communicate with other users, or the like. Also, client computers may be arranged to enable users to display reports, interactive user-interfaces, or results provided by sensing systems 718 or scanning devices 720.

Wireless network 708 is configured to couple client computers 703-705 and its components with network 710. Wireless network 708 may include any of a variety of wireless sub-networks that may further overlay stand-alone ad-hoc networks, and the like, to provide an infrastructure-oriented connection for client computers 703-705. Such sub-networks may include mesh networks, Wireless LAN (WLAN) networks, cellular networks, and the like. In one or more embodiments, the system may include more than one wireless network.

Wireless network 708 may further include an autonomous system of terminals, gateways, routers, and the like connected by wireless radio links, and the like. These connectors may be configured to move freely and randomly and organize themselves arbitrarily, such that the topology of wireless network 708 may change rapidly.

Wireless network 708 may further employ a plurality of access technologies including 2nd (2G), 3rd (3G), 4th (4G) 5th (5G) generation radio access for cellular systems, WLAN, Wireless Router (WR) mesh, and the like. Access technologies such as 2G, 3G, 4G, 5G, and future access networks may enable wide area coverage for mobile computers, such as client computers 703-705 with various degrees of mobility. In one non-limiting example, wireless network 708 may enable a radio connection through a radio network access such as Global System for Mobil communication (GSM), General Packet Radio Services (GPRS), Enhanced Data GSM Environment (EDGE), code division multiple access (CDMA), time division multiple access (TDMA), Wideband Code Division Multiple Access (WCDMA), High Speed Downlink Packet Access (HSDPA), Long Term Evolution (LTE), and the like. In essence, wireless network 708 may include virtually any wireless communication mechanism by which information may travel between client computers 703-705 and another computer, network, a cloud-based network, a cloud instance, or the like.

Network 710 is configured to couple network computers with other computers, including, application server computer 716, sensing systems 718, scanning devices 720, client computers 702, and client computers 703-705 through wireless network 708, or the like. Network 710 is enabled to employ any form of computer readable media for communicating information from one electronic device to another. Also, network 710 can include the Internet in addition to local area networks (LANs), wide area networks (WANs), direct connections, such as through a universal serial bus (USB) port, Ethernet port, other forms of computer-readable media, or any combination thereof. On an interconnected set of LANs, including those based on differing architectures and protocols, a router acts as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, or other carrier mechanisms including, for example, E-carriers, Integrated Services Digital Networks (ISDNs), Digital Subscriber Lines (DSLs), wireless links including satellite links, or other communications links known to those skilled in the art. Moreover, communication links may further employ any of a variety of digital signaling technologies, including without limit, for example, DS-0, DS-1, DS-2, DS-3, DS-4, OC-3, OC-12, OC-48, or the like. Furthermore, remote computers and other related electronic devices may be remotely connected to either LANs or WANs via a modem and temporary telephone link. In one or more embodiments, network 710 may be configured to transport information of an Internet Protocol (IP).

Additionally, communication media typically embodies computer readable instructions, data structures, program modules, or other transport mechanism and includes any information non-transitory delivery media or transitory delivery media. By way of example, communication media includes wired media such as twisted pair, coaxial cable, fiber optics, wave guides, and other wired media and wireless media such as acoustic, RF, infrared, and other wireless media.

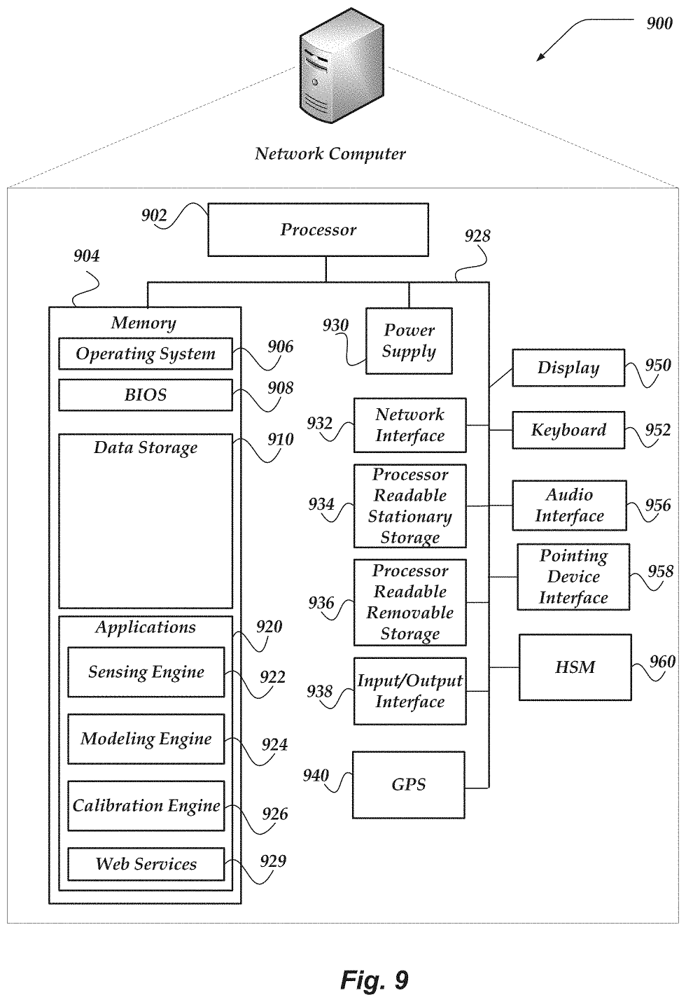

Also, one embodiment of application server computer 716, sensing systems 718 or scanning devices 720 are described in more detail below in conjunction with FIG. 8 or FIG. 9. Although FIG. 7 illustrates application server computer 716, sensing systems 718, and scanning devices 720 each as a single computer, the innovations or embodiments are not so limited. For example, one or more functions of application server computer 716, sensing systems 718, scanning devices 720, or the like, may be distributed across one or more distinct network computers or client computers. Moreover, in one or more embodiments, sensing systems 718 may be implemented using a plurality of network computers. Further, in one or more of the various embodiments, application server computer 716, sensing systems 718, or the like, may be implemented using one or more cloud instances in one or more cloud networks. Accordingly, these innovations and embodiments are not to be construed as being limited to a single environment, and other configurations, and other architectures are also envisaged.

### Illustrative Client Computer

FIG. 8 shows one embodiment of client computer 800 that may include many more or less components than those shown. Client computer 800 may represent, for example, one or more embodiments of mobile computers or client computers shown in FIG. 7. Further, scanning devices, mobile phones, scanning devices, or the like, discussed above may be considered client computers that may be arranged in configurations or form factors as described above.

Client computer 800 may include processor 802 in communication with memory 804 via bus 828. Client computer 800 may also include power supply 830, network interface 832, audio interface 856, display 850, keypad 852, illuminator 854, video interface 842, input/output interface 838, haptic interface 864, global positioning systems (GPS) receiver 858, open air gesture interface 860, temperature interface 862, camera(s) 840, projector 846, pointing device interface 866, processor-readable stationary storage device 834, and processor-readable removable storage device 836. Client computer 800 may optionally communicate with a base station (not shown), or directly with another computer. And in one or more embodiments, although not shown, a gyroscope may be employed within client computer 800 to measuring or maintaining an orientation of client computer 800.

Power supply 830 may provide power to client computer 800. A rechargeable or non-rechargeable battery may be used to provide power. The power may also be provided by an external power source, such as an AC adapter or a powered docking cradle that supplements or recharges the battery.

Network interface 832 includes circuitry for coupling client computer 800 to one or more networks, and is constructed for use with one or more communication protocols and technologies including, but not limited to, protocols and technologies that implement any portion of the OSI model for mobile communication (GSM), CDMA, time division multiple access (TDMA), UDP, TCP/IP, SMS, MMS, GPRS, WAP, UWB, WiMax, SIP/RTP, GPRS, EDGE, WCDMA, LTE, UMTS, OFDM, CDMA2000, EV-DO, HSDPA, or any of a variety of other wireless communication protocols. Network interface 832 is sometimes known as a transceiver, transceiving device, or network interface card (MC).

Audio interface 856 may be arranged to produce and receive audio signals such as the sound of a human voice. For example, audio interface 856 may be coupled to a speaker and microphone (not shown) to enable telecommunication with others or generate an audio acknowledgement for some action. A microphone in audio interface 856 can also be used for input to or control of client computer 800, e.g., using voice recognition, detecting touch based on sound, and the like.

Display 850 may be a liquid crystal display (LCD), gas plasma, electronic ink, light emitting diode (LED), Organic LED (OLED) or any other type of light reflective or light transmissive display that can be used with a computer. Display 850 may also include a touch interface 844 arranged to receive input from an object such as a stylus or a digit from a human hand, and may use resistive, capacitive, surface acoustic wave (SAW), infrared, radar, or other technologies to sense touch or gestures.

Projector 846 may be a remote handheld projector or an integrated projector that is capable of projecting an image on a remote wall or any other reflective object such as a remote screen.

Also, in some embodiments, if client computer 200 may be a scanning device, projector 846 may include one or more signal beam generators, laser scanner systems, or the like, that may be employed for scanning scene or objects as described above.

Video interface 842 may be arranged to capture video images, such as a still photo, a video segment, an infrared video, or the like. For example, video interface 842 may be coupled to a digital video camera, a web-camera, or the like. Video interface 842 may comprise a lens, an image sensor, and other electronics. Image sensors may include a complementary metal-oxide-semiconductor (CMOS) integrated circuit, charge-coupled device (CCD), or any other integrated circuit for sensing light.

Keypad 852 may comprise any input device arranged to receive input from a user. For example, keypad 852 may include a push button numeric dial, or a keyboard. Keypad 852 may also include command buttons that are associated with selecting and sending images.

Illuminator 854 may provide a status indication or provide light. Illuminator 854 may remain active for specific periods of time or in response to event messages. For example, if illuminator 854 is active, it may backlight the buttons on keypad 852 and stay on while the client computer is powered. Also, illuminator 854 may backlight these buttons in various patterns if particular actions are performed, such as dialing another client computer. Illuminator 854 may also cause light sources positioned within a transparent or translucent case of the client computer to illuminate in response to actions.

Further, client computer 800 may also comprise hardware security module (HSM) 868 for providing additional tamper resistant safeguards for generating, storing or using security/cryptographic information such as, keys, digital certificates, passwords, passphrases, two-factor authentication information, or the like. In some embodiments, hardware security module may be employed to support one or more standard public key infrastructures (PKI), and may be employed to generate, manage, or store keys pairs, or the like. In some embodiments, HSM 868 may be a stand-alone computer, in other cases, HSM 868 may be arranged as a hardware card that may be added to a client computer.

Client computer 800 may also comprise input/output interface 838 for communicating with external peripheral devices or other computers such as other client computers and network computers. The peripheral devices may include an audio headset, virtual reality headsets, display screen glasses, remote speaker system, remote speaker and microphone system, and the like. Input/output interface 838 can utilize one or more technologies, such as Universal Serial Bus (USB), Infrared, WiFi, WiMax, Bluetooth™, and the like.

Input/output interface 838 may also include one or more sensors for determining geolocation information (e.g., GPS), monitoring electrical power conditions (e.g., voltage sensors, current sensors, frequency sensors, and so on), monitoring weather (e.g., thermostats, barometers, anemometers, humidity detectors, precipitation scales, or the like), or the like. Sensors may be one or more hardware sensors that collect or measure data that is external to client computer 800.

Haptic interface 864 may be arranged to provide tactile feedback to a user of the client computer. For example, the haptic interface 864 may be employed to vibrate client computer 800 in a particular way if another user of a computer is calling. Temperature interface 862 may be used to provide a temperature measurement input or a temperature changing output to a user of client computer 800. Open air gesture interface 860 may sense physical gestures of a user of client computer 800, for example, by using single or stereo video cameras, radar, a gyroscopic sensor inside a computer held or worn by the user, or the like. Camera 840 may be used to track physical eye movements of a user of client computer 800.

Further, in some cases, if client computer 800 may be a scanning device, camera 840 may represent one or more event cameras, one or more frame cameras, or the like.

GPS transceiver 858 can determine the physical coordinates of client computer 800 on the surface of the Earth, which typically outputs a location as latitude and longitude values. GPS transceiver 858 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of client computer 800 on the surface of the Earth. It is understood that under different conditions, GPS transceiver 858 can determine a physical location for client computer 800. In one or more embodiment, however, client computer 800 may, through other components, provide other information that may be employed to determine a physical location of the client computer, including for example, a Media Access Control (MAC) address, IP address, and the like.

In at least one of the various embodiments, applications, such as, operating system 806, other client apps 824, web browser 826, or the like, may be arranged to employ geo-location information to select one or more localization features, such as, time zones, languages, currencies, calendar formatting, or the like. Localization features may be used in, file systems, user-interfaces, reports, as well as internal processes or databases. In at least one of the various embodiments, geo-location information used for selecting localization information may be provided by GPS 858. Also, in some embodiments, geolocation information may include information provided using one or more geolocation protocols over the networks, such as, wireless network 708 or network 711.

Human interface components can be peripheral devices that are physically separate from client computer 800, allowing for remote input or output to client computer 800. For example, information routed as described here through human interface components such as display 850 or keyboard 852 can instead be routed through network interface 832 to appropriate human interface components located remotely. Examples of human interface peripheral components that may be remote include, but are not limited to, audio devices, pointing devices, keypads, displays, cameras, projectors, and the like. These peripheral components may communicate over a Pico Network such as Bluetooth™, Zigbee™ and the like. One non-limiting example of a client computer with such peripheral human interface components is a wearable computer, which might include a remote pico projector along with one or more cameras that remotely communicate with a separately located client computer to sense a user's gestures toward portions of an image projected by the pico projector onto a reflected surface such as a wall or the user's hand.

A client computer may include web browser application 826 that is configured to receive and to send web pages, web-based messages, graphics, text, multimedia, and the like. The client computer's browser application may employ virtually any programming language, including a wireless application protocol messages (WAP), and the like. In one or more embodiment, the browser application is enabled to employ Handheld Device Markup Language (HDML), Wireless Markup Language (WML), WMLScript, JavaScript, Standard Generalized Markup Language (SGML), HyperText Markup Language (HTML), eXtensible Markup Language (XML), HTML5, and the like.

Memory 804 may include RAM, ROM, or other types of memory. Memory 804 illustrates an example of computer-readable storage media (devices) for storage of information such as computer-readable instructions, data structures, program modules or other data. Memory 804 may store BIOS 808 for controlling low-level operation of client computer 800. The memory may also store operating system 806 for controlling the operation of client computer 800. It will be appreciated that this component may include a general-purpose operating system such as a version of UNIX, or Linux®, or a specialized client computer communication operating system such as Windows Phone™, or the Symbian® operating system. The operating system may include, or interface with a Java virtual machine module that enables control of hardware components or operating system operations via Java application programs.

Memory 804 may further include one or more data storage 810, which can be utilized by client computer 800 to store, among other things, applications 820 or other data. For example, data storage 810 may also be employed to store information that describes various capabilities of client computer 800. The information may then be provided to another device or computer based on any of a variety of methods, including being sent as part of a header during a communication, sent upon request, or the like. Data storage 810 may also be employed to store social networking information including address books, buddy lists, aliases, user profile information, or the like. Data storage 810 may further include program code, data, algorithms, and the like, for use by a processor, such as processor 802 to execute and perform actions. In one embodiment, at least some of data storage 810 might also be stored on another component of client computer 800, including, but not limited to, non-transitory processor-readable removable storage device 836, processor-readable stationary storage device 834, or even external to the client computer.

Applications 820 may include computer executable instructions which, if executed by client computer 800, transmit, receive, or otherwise process instructions and data. Applications 820 may include, for example, other client applications 824, web browser 826, or the like. Client computers may be arranged to exchange communications, such as, queries, searches, messages, notification messages, event messages, sensor events, alerts, performance metrics, log data, API calls, or the like, combination thereof, with application servers or network monitoring computers.

Other examples of application programs include calendars, search programs, email client applications, IM applications, SMS applications, Voice Over Internet Protocol (VOIP) applications, contact managers, task managers, transcoders, database programs, word processing programs, security applications, spreadsheet programs, games, search programs, and so forth.

Additionally, in one or more embodiments (not shown in the figures), client computer 800 may include an embedded logic hardware device instead of a CPU, such as, an Application Specific Integrated Circuit (ASIC), Field Programmable Gate Array (FPGA), Programmable Array Logic (PAL), or the like, or combination thereof. The embedded logic hardware device may directly execute its embedded logic to perform actions. Also, in one or more embodiments (not shown in the figures), client computer 800 may include one or more hardware microcontrollers instead of CPUs. In one or more embodiment, the one or more microcontrollers may directly execute their own embedded logic to perform actions and access its own internal memory and its own external Input and Output Interfaces (e.g., hardware pins or wireless transceivers) to perform actions, such as System On a Chip (SOC), or the like.

### Illustrative Network Computer

FIG. 9 shows one embodiment of network computer 900 that may be included in a system implementing one or more of the various embodiments. Network computer 900 may include many more or less components than those shown in FIG. 9. However, the components shown are sufficient to disclose an illustrative embodiment for practicing these innovations. Network computer 900 may represent, for example, one embodiment of at least one of application server computer 716, or sensing systems 718 of FIG. 7.

In one or more of the various embodiments, scanning devices, mobile computers, or mobile phones may be arranged to communicate with one or more network computers, such as, network computer 900. Accordingly, in some embodiments, scanning devices, mobile computers, mobile phones used as auxiliary devices for augmented reality may be arranged to upload or download data from one or more network computers. In some embodiments, network computers may provide: software/firmware updates; backup storage; communication between or among scanning devices, mobile computers; or the like. In some cases, network computer 900 may be considered part of a cloud-based system that provides computational support for scanning devices, mobile computers, or mobile phones used for auxiliary devices for augmented reality.

Network computers, such as, network computer 900 may include a processor 902 that may be in communication with a memory 904 via a bus 928. In some embodiments, processor 902 may be comprised of one or more hardware processors, or one or more processor cores. In some cases, one or more of the one or more processors may be specialized processors designed to perform one or more specialized actions, such as, those described herein. Network computer 900 also includes a power supply 930, network interface 932, audio interface 956, display 950, keyboard 952, input/output interface 938, processor-readable stationary storage device 934, and processor-readable removable storage device 936. Power supply 930 provides power to network computer 900.

Network interface 932 includes circuitry for coupling network computer 900 to one or more networks, and is constructed for use with one or more communication protocols and technologies including, but not limited to, protocols and technologies that implement any portion of the Open Systems Interconnection model (OSI model), global system for mobile communication (GSM), code division multiple access (CDMA), time division multiple access (TDMA), user datagram protocol (UDP), transmission control protocol/Internet protocol (TCP/IP), Short Message Service (SMS), Multimedia Messaging Service (MMS), general packet radio service (GPRS), WAP, ultra-wide band (UWB), IEEE 802.16 Worldwide Interoperability for Microwave Access (WiMax), Session Initiation Protocol/Real-time Transport Protocol (SIP/RTP), or any of a variety of other wired and wireless communication protocols. Network interface 932 is sometimes known as a transceiver, transceiving device, or network interface card (NIC). Network computer 900 may optionally communicate with a base station (not shown), or directly with another computer.

Audio interface 956 is arranged to produce and receive audio signals such as the sound of a human voice. For example, audio interface 956 may be coupled to a speaker and microphone (not shown) to enable telecommunication with others or generate an audio acknowledgement for some action. A microphone in audio interface 956 can also be used for input to or control of network computer 900, for example, using voice recognition.

Display 950 may be a liquid crystal display (LCD), gas plasma, electronic ink, light emitting diode (LED), Organic LED (OLED) or any other type of light reflective or light transmissive display that can be used with a computer. In some embodiments, display 950 may be a handheld projector or pico projector capable of projecting an image on a wall or other object.

Network computer 900 may also comprise input/output interface 938 for communicating with external devices or computers not shown in FIG. 9. Input/output interface 938 can utilize one or more wired or wireless communication technologies, such as USB™, Firewire™, WiFi, WiMax, Thunderbolt™, Infrared, Bluetooth™, Zigbee™, serial port, parallel port, and the like.

Also, input/output interface 938 may also include one or more sensors for determining geolocation information (e.g., GPS), monitoring electrical power conditions (e.g., voltage sensors, current sensors, frequency sensors, and so on), monitoring weather (e.g., thermostats, barometers, anemometers, humidity detectors, precipitation scales, or the like), or the like. Sensors may be one or more hardware sensors that collect or measure data that is external to network computer 900. Human interface components can be physically separate from network computer 900, allowing for remote input or output to network computer 900. For example, information routed as described here through human interface components such as display 950 or keyboard 952 can instead be routed through the network interface 932 to appropriate human interface components located elsewhere on the network. Human interface components include any component that allows the computer to take input from, or send output to, a human user of a computer. Accordingly, pointing devices such as mice, styluses, track balls, or the like, may communicate through pointing device interface 958 to receive user input.

GPS transceiver 940 can determine the physical coordinates of network computer 900 on the surface of the Earth, which typically outputs a location as latitude and longitude values. GPS transceiver 940 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of network computer 900 on the surface of the Earth. It is understood that under different conditions, GPS transceiver 940 can determine a physical location for network computer 900. In one or more embodiments, however, network computer 900 may, through other components, provide other information that may be employed to determine a physical location of the client computer, including for example, a Media Access Control (MAC) address, IP address, and the like.

In at least one of the various embodiments, applications, such as, operating system 906, sensing engine 922, modeling engine 924, calibration engine 926, web services 929, or the like, may be arranged to employ geo-location information to select one or more localization features, such as, time zones, languages, currencies, currency formatting, calendar formatting, or the like. Localization features may be used in file systems, user-interfaces, reports, as well as internal processes or databases. In at least one of the various embodiments, geo-location information used for selecting localization information may be provided by GPS 940. Also, in some embodiments, geolocation information may include information provided using one or more geolocation protocols over the networks, such as, wireless network 108 or network 111.

Memory 904 may include Random Access Memory (RAM), Read-Only Memory (ROM), or other types of memory. Memory 904 illustrates an example of computer-readable storage media (devices) for storage of information such as computer-readable instructions, data structures, program modules or other data. Memory 904 stores a basic input/output system (BIOS) 908 for controlling low-level operation of network computer 900. The memory also stores an operating system 906 for controlling the operation of network computer 900. It will be appreciated that this component may include a general-purpose operating system such as a version of UNIX®, or Linux®, or a specialized operating system such as Microsoft Corporation's Windows® operating system, or the Apple Corporation's macOS® operating system. The operating system may include, or interface with one or more virtual machine modules, such as, a Java virtual machine module that enables control of hardware components or operating system operations via Java application programs. Likewise, other runtime environments may be included.

Memory 904 may further include one or more data storage 910, which can be utilized by network computer 900 to store, among other things, applications 920 or other data. For example, data storage 910 may also be employed to store information that describes various capabilities of network computer 900. The information may then be provided to another device or computer based on any of a variety of methods, including being sent as part of a header during a communication, sent upon request, or the like. Data storage 910 may also be employed to store social networking information including address books, buddy lists, aliases, user profile information, or the like. Data storage 910 may further include program code, data, algorithms, and the like, for use by a processor, such as processor 902 to execute and perform actions such as those actions described below. in one or more embodiments, at least some of data storage 910 might also be stored on another component of network computer 900, including, but not limited to, non-transitory media inside processor-readable removable storage device 936, processor-readable stationary storage device 934, or any other computer-readable storage device within network computer 900, or even external to network computer 900.

Applications 920 may include computer executable instructions which, if executed by network computer 900, transmit, receive, or otherwise process messages (e.g., SMS, Multimedia Messaging Service (MMS), Instant Message (IM), email, or other messages), audio, video, and enable telecommunication with another user of another mobile computer. Other examples of application programs include calendars, search programs, email client applications, IM applications, SMS applications, Voice Over Internet Protocol (VOIP) applications, contact managers, task managers, transcoders, database programs, word processing programs, security applications, spreadsheet programs, games, search programs, and so forth. Applications 920 may include sensing engine 922, modeling engine 924, calibration engine 926, web services 929, or the like, which may be arranged to perform actions for embodiments described below. In one or more of the various embodiments, one or more of the applications may be implemented as modules or components of another application. Further, in one or more of the various embodiments, applications may be implemented as operating system extensions, modules, plugins, or the like.

Furthermore, in one or more of the various embodiments, sensing engine 922, modeling engine 924, calibration engine 926, web services 929, or the like, may be operative in a cloud-based computing environment. In one or more of the various embodiments, these applications, and others, which comprise the management platform may be executing within virtual machines or virtual servers that may be managed in a cloud-based based computing environment. In one or more of the various embodiments, in this context the applications may flow from one physical network computer within the cloud-based environment to another depending on performance and scaling considerations automatically managed by the cloud computing environment. Likewise, in one or more of the various embodiments, virtual machines or virtual servers dedicated to sensing engine 922, modeling engine 924, calibration engine 926, web services 929, or the like, may be provisioned and de-commissioned automatically.

Also, in one or more of the various embodiments, sensing engine 922, modeling engine 924, calibration engine 926, web services 929, or the like, may be located in virtual servers running in a cloud-based computing environment rather than being tied to one or more specific physical network computers.

Further, network computer 900 may also comprise hardware security module (HSM) 960 for providing additional tamper resistant safeguards for generating, storing or using security/cryptographic information such as, keys, digital certificates, passwords, passphrases, two-factor authentication information, or the like. In some embodiments, hardware security module may employ to support one or more standard public key infrastructures (PKI), and may be employed to generate, manage, or store keys pairs, or the like. In some embodiments, HSM 960 may be a stand-alone network computer, in other cases, HSM 960 may be arranged as a hardware card that may be installed in a network computer.

Additionally, in one or more embodiments (not shown in the figures), network computer 900 may include an embedded logic hardware device instead of a CPU, such as, an Application Specific Integrated Circuit (ASIC), Field Programmable Gate Array (FPGA), Programmable Array Logic (PAL), or the like, or combination thereof. The embedded logic hardware device may directly execute its embedded logic to perform actions. Also, in one or more embodiments (not shown in the figures), the network computer may include one or more hardware microcontrollers instead of a CPU. In one or more embodiment, the one or more microcontrollers may directly execute their own embedded logic to perform actions and access their own internal memory and their own external Input and Output Interfaces (e.g., hardware pins or wireless transceivers) to perform actions, such as System On a Chip (SOC), or the like.

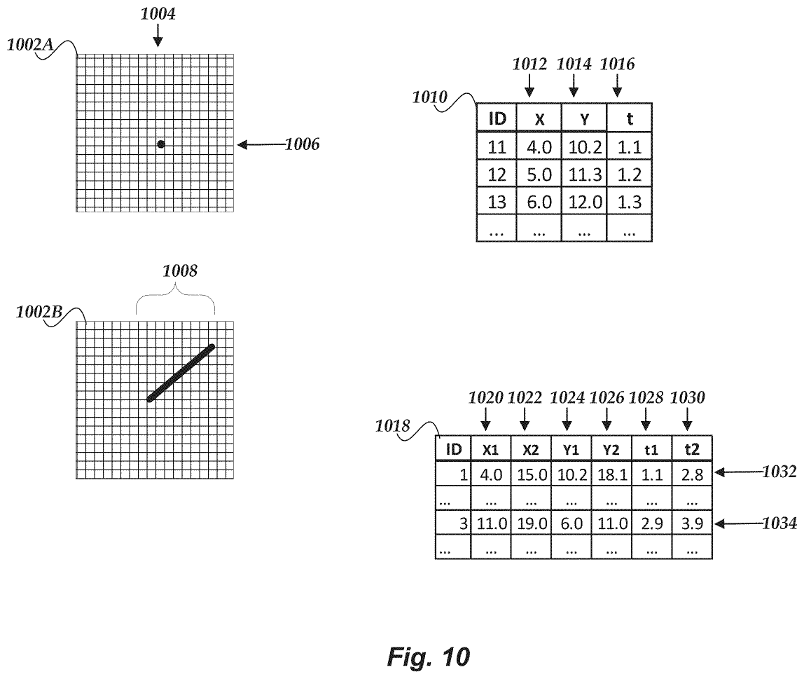

FIG. 10 illustrates a logical representation of sensors and sensor output information for auxiliary device for augmented reality in accordance with one or more of the various embodiments.

In one or more of the various embodiments, sensing engines running on scanning devices, such as, scanning device 118 may be provided sensor output from various sensors. In this example, for some embodiments, sensor 1002A may be considered to represent a generic sensor that may emit signals that correspond to the precise location on the sensor where reflected energy from the scanning signal generator may be detected. For example, sensor 1002A may be considered an array of detector cells that reports the cell location of the cell that has detected energy reflected from the scanning signal generator. In this example, horizontal location 1004 and vertical location 1006 may be considered to represent a location corresponding to the location in sensor 1002 where reflected signal energy has been detected. Accordingly, sensor 1002 may be considered a sensor that may be part of an event camera that may be included in a scanning device, such as, scanning device 118 where the signal energy may be provided scanning lasers and the reflect signal energy may be considered the laser light that may be reflected from one or more objects or surfaces in the scene.

In one or more of the various embodiments, sensing engines may be arranged to receive sensor information for one or more detection events from one or more sensors. Accordingly, in some embodiments, sensing engines may be arranged to determine additional information about the source of the reflected energy (beam location on scanned surface) based on triangulation or other methods. In some embodiments, if sensing engines employ triangulation or other methods to locate the location of the signal beam in the scanning environment, the combined sensor information may be considered a single sensor event comprising a horizontal (x) location, vertical location (y) and time component (t). Also, in some embodiments, sensor event may include other information, such as, time-of-flight information depending on the type or capability of the sensors.

Further, as described above, the scanning signal generator (e.g., scanning laser) may be configured to traverse a known precise path/curve (e.g., scanning path). Accordingly, in some embodiments, the pattern or sequence of cells in the sensors that detect reflected energy will follow a path/curve that is related to the path/curve of the scanning signal generator. Accordingly, in some embodiments, if the signal generator scans a particular path/curve a related path/curve of activated cells in the sensors may be detected. Thus, in this example, for some embodiments, path 1008 may represent a sequence of cells in sensor 1002B that have detected reflected energy from the scanning signal generator.

In one or more of the various embodiments, sensing engines may be arranged to fit sensor events to the scanning path curve. Accordingly, in one or more of the various embodiments, sensing engines may be arranged to predict where sensor events should occur based on the scanning path curve to determine information about the location or orientation of scanned surfaces or objects. Thus, in some embodiments, if sensing engines receive sensor events that are unassociated with the known scanning path curve, sensing engines may be arranged to perform various actions, such as, closing the current trajectory and beginning a new trajectory, discarding the sensor event as noise, or the like.

In one or more of the various embodiments, scanning path curves may be configured in advance within the limits or constraints of the scanning signal generator and the sensors. For example, a scanning signal generator may be configured or directed to scan the scanning environment using various curves including Lissajous curves, 2D lines, or the like. In some cases, scanning path curves may be considered piece-wise functions in that they may change direction or shape at different parts of the scan. For example, a 2D line scan path may be configured to change direction if the edge of the scanning environment (e.g., field-of-view) is approached.

One of ordinary skill in the art will appreciate that if an unobstructed surface is scanned, the scanning frequency, scanning path, and sensor response frequency may determine if the sensor detection path appears as a continuous path. Thus, the operational requirements of the scanning signal generator, sensor precision, sensor response frequency, or the like, may vary depending on application of the system. For example, if the scanning environment may be relatively low featured and static, the sensors may have a lower response time because the scanned environment is not changing very fast. Also, for example, if the scanning environment is dynamic or includes more features of interest, the sensors may require increased responsiveness or precision to accurately capture the paths of the reflected signal energy. Further, in some embodiments, the characteristics of the scanning signal generator may vary depending on the scanning environment. For example, if lasers are used for the scanning signal generator, the energy level, wavelength, phase, beam width, or the like, may be tuned to suit the environment.

In one or more of the various embodiments, sensing engines may be provided sensor output as a continuous stream of sensor events or sensor information that identifies the cell location in the sensor cell-array and a timestamp that corresponds to if the detection event occurred.

In this example, for some embodiments, data structure 1010 may be considered a data structure for representing sensor events based on sensor output provided to a sensing engine. In this example, column 1012 represents the horizontal position of the location in the scanning environment, column 1014 represents a vertical position in the scanning environment, and column 1016 represents the time of the event. Accordingly, in some embodiments, sensing engines may be arranged to determine which (if any) sensor events should be associated with a trajectory. In some embodiments, sensing engines may be arranged to associate sensor events with existing trajectories or create new trajectories. In some embodiments, if the sensor events fit an expected/predicted curve as determined based on the scanning path curve, sensing engines may be arranged to associate the sensor events with an existing trajectory or create a new trajectory. Also, in some cases, for some embodiments, sensing engines may be arranged to determine one or more sensor event as noise if their location deviates from a predicted path beyond a defined threshold value.

In one or more of the various embodiments, sensing engines may be arranged to determine sensor events for each individual sensor rather being limited to provide sensor events computed based on outputs from multiple sensors. For example, in some embodiments, sensing engines may be arranged to provide a data structure similar to data structure 1010 to collect sensor events for individual sensors.

In some embodiments, sensing engines may be arranged to generate a sequence of trajectories that correspond to the reflected energy/signal paths detected by the sensors. In some embodiments, sensing engines may be arranged to employ one or more data structures, such as, data structure 1018 to represent a trajectory that may be determined based on the information captured by the sensors. In this example, data structure 1010 may be table-like structure that includes columns, such as, column 1020 for storing a first x-position, column 1022 for storing a second x-position, column 1024 for storing a first y-position, column 1026 for storing a second y-position, column 1028 for storing the beginning time of a trajectory, column 1030 for storing an end time of a trajectory, of the like.

In this example, row 1032 represents information for a first trajectory and row 1034 represents information for another trajectory. As described herein, sensing engines may be arranged to employ one or more rules or heuristics to determine if one trajectory ends and another begins. In some embodiments, such heuristics may include observing the occurrence sensor events that are geometrically close or temporally close. Note, the particular components or elements of a trajectory may vary depending on the parametric representation of the analytical curve or the type of analytical curve associated with the scanning path and the shape or orientation of the scanned surfaces. Accordingly, one of ordinary skill in the art will appreciate that different types of analytical curves or curve representations may result in more or fewer parameters for each trajectory. Thus, in some embodiments, sensing engines may be arranged to determine the specific parameters for trajectories based on rules, templates, libraries, or the like, provided via configuration information to account for local circumstances or local requirements.

Further, one of ordinary skill in the art will appreciate that in some embodiments, trajectories may be projected/converted into 3-D scene coordinates based on calibration information, such as, the position or orientation of sensors, signal generators (e.g., scanning lasers), or the like.

In one or more of the various embodiments, trajectories may be represented using curve parameters rather than a collection of individual points or pixels. Accordingly, in some embodiments, sensing engines may be arranged to employ one or more numerical methods to continuously fit sequences of sensor events to scanning path curves.

Further, in some embodiments, sensing engines may be arranged to employ one or more smoothing methods to improve the accuracy of trajectories or trajectory fitting. For example, in some embodiments, the scanning curve may be comprised of sensor events triggered by a scanning laser that may not be one cell wide because in some cases reflected energy may splash to neighboring cells or land on the border of two or more cells. Accordingly, in some embodiments, to better estimate the real position of the reflected signal beam as it traverses the sensor plane, sensing engines may be arranged to perform an online smoothing estimate, e.g., using a Kalman filter to predict a position in a trajectory in fractional units of detector cell position and fractional units of the fundamental timestamp of the sensor. Also, in some embodiments, sensing engines may be arranged to employ a batch-based optimization routine such as weighted least squares to fit a smooth curve to continuous segments of the scanning trajectory, which may correspond to when the scanning signal generator beam was scanning over a continuous surface.

Also, in some embodiments, the scanning path may be employed to determine if trajectories begin or end. For example, if the scanning path reaches an edge of a scanning area and changes direction, in some cases, a current trajectory may be terminated while a new trajectory may be started to begin capturing information based on the new direction of the scan. Also, in some embodiments, objects or other features that occlude or obstruct scanning energy or reflected scanning energy may result in breaks in the sensor output that introduce gaps or other discontinuities that may trigger a trajectory to be closed and another trajectory to be opened subsequent to the break or gap. Further, in some embodiments, sensing engines may be configured to have a maximum length of trajectories such that a trajectory may be closed if it has collected enough sensor events or enough time has elapsed from the start of the trajectory.

Also, in some embodiments, sensing engines may be arranged to determine trajectories for individual sensor. Accordingly, in some embodiments, sensing engines may be arranged to provide data structures similar to data structure 1018 for each sensor. Thus, the relative position information for different sensors or different collections of the data may be used to compute 3-D coordinates for events or trajectories.

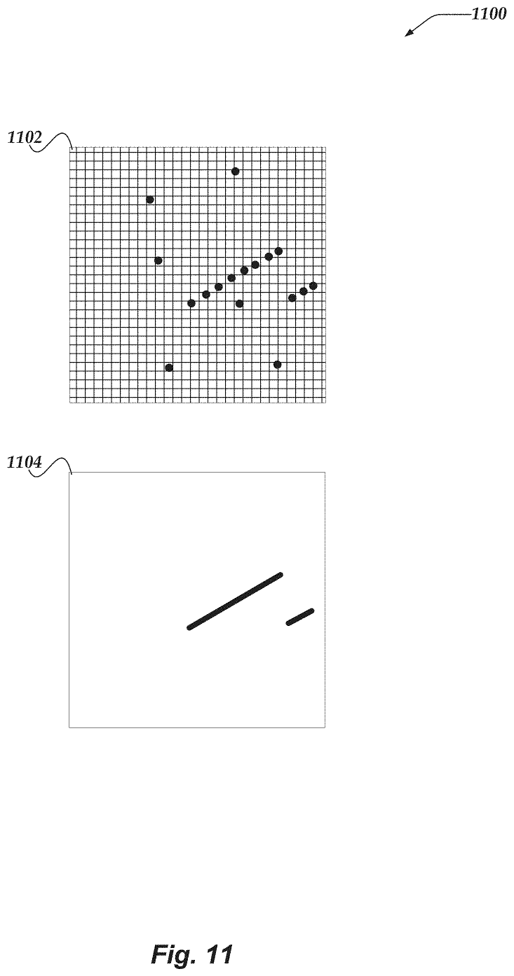

FIG. 11 illustrates a logical schematic of system 1100 for auxiliary devices for augmented reality in accordance with one or more of the various embodiments. As described above, in some embodiments, scanning signal generators may scan for surfaces in scanning environments. In some cases, conditions of the scanning environment or characteristics of the scanned surfaces may result in one or more spurious sensor events (e.g., noise) generated by one or more sensors. For example, sensor view 1102 represents a portion of sensor events that may be generated during a scan.

In conventional machine vision applications, one or more 2D filters may be applied to a captured video image, point clusters, or the like, to attempt to separate noise events from the signals of interest. In some cases, conventional 2D image-based filters may be disadvantageous because they may employ one or more filters (e.g., weighted moving averaging, Gaussian filters, or the like) that may rely on statistical evaluation of pixel color/weight, pixel color/weight gradients, pixel distribution/clustering, or the like. Accordingly, in some cases, conventional 2D image filtering may be inherently fuzzy and highly dependent on application/environmental assumptions. Also, in some cases, conventional noise detection/noise reduction methods may erroneously miss some noise events while at the same time misclassifying one or more scene events as noise.

In contrast, in some embodiments, sensing engines may be arranged to associate sensor events into trajectories based on precise heuristics, such as, nearness in time and location that may be used to fit sensor events to analytical curves that may be predicted based on the scanning path. Because scanning paths are defined in advance, sensing engines may be arranged to predict which sensor events should be included in the same trajectory. See, trajectory view 1104.

Further, in some embodiments, if surface or object features create gaps or breaks in trajectories, sensing engines may be arranged to close the current trajectory and start a new trajectory as soon as one may be recognized.

Also, in some embodiments, sensing engines may be arranged to determine trajectories directly from sensor events having the form (x, y, t) rather than employing fuzzy pattern matching or pattern recognition methods. Thus, in some embodiments, sensing engines may be arranged to accurately compute distance, direction, or the like, rather than relying fuzzy machine vision methods to distinguish noise from sensor events that should be in the same trajectory.

In one or more of the various embodiments, calibration engines associated with sensing engines or scanning devices may be arranged to employ rules, instructions, heuristics, or the like, for classifying sensor events as noise that may be provided via configuration information to account for local requirements or local circumstances that may be associated with a sensing applications or sensors.

Also, this will be understood that each block (or step) in each flowchart illustration, and combinations of blocks in each flowchart illustration, may be implemented by computer program instructions. These program instructions may be provided to a processor to produce a machine, such that the instructions, which execute on the processor, create means for implementing the actions specified in each flowchart block or blocks. The computer program instructions may be executed by a processor to cause a series of operational steps to be performed by the processor to produce a computer-implemented process such that the instructions, which execute on the processor, provide steps for implementing the actions specified in each flowchart block or blocks. The computer program instructions may also cause at least some of the operational steps shown in the blocks of each flowchart to be performed in parallel. Moreover, some of the steps may also be performed across more than one processor, such as may arise in a multi-processor computer system. In addition, one or more blocks or combinations of blocks in each flowchart illustration may also be performed concurrently with other blocks or combinations of blocks, or even in a different sequence than illustrated without departing from the scope or spirit of the innovations.

Accordingly, each block (or step) in each flowchart illustration supports combinations of means for performing the specified actions, combinations of steps for performing the specified actions and program instruction means for performing the specified actions. It will also be understood that each block in each flowchart illustration, and combinations of blocks in each flowchart illustration, may be implemented by special purpose hardware based systems, which perform the specified actions or steps, or combinations of special purpose hardware and computer instructions. The foregoing example should not be construed as limiting or exhaustive, but rather, an illustrative use case to show an implementation of at least one of the various embodiments of the innovations.

Further, in one or more embodiments (not shown in the figures), the logic in the illustrative flowcharts may be executed using an embedded logic hardware device instead of a CPU, such as, an Application Specific Integrated Circuit (ASIC), Field Programmable Gate Array (FPGA), Programmable Array Logic (PAL), or the like, or combination thereof. The embedded logic hardware device may directly execute its embedded logic to perform actions. In one or more embodiments, a microcontroller may be arranged to directly execute its own embedded logic to perform actions and access its own internal memory and its own external Input and Output Interfaces (e.g., hardware pins or wireless transceivers) to perform actions, such as System On a Chip (SOC), or the like.

Further, in some cases, for brevity or clarity, signal generators may be referred to above as lasers, scanning lasers, or the like. Accordingly, one of ordinary skill in the art will appreciate that such specific references may be considered to be signal generators. Likewise, in some cases, sensors, event sensors, image sensors, or the like, may be referred to as cameras, event cameras, image cameras, frame capture cameras, or the like. Accordingly, one of ordinary skill in the art will appreciate that such specific references may be considered to be sensors, event sensors, image sensors, or the like.

What is claimed as new and desired to be protected by Letters Patent of the United States is:

1. A method for sensing objects using one or more processors to execute instructions that are configured to cause actions, comprising:
capturing one or more images of a scene with one or more frame cameras included in a mobile computer;
scanning a plurality of paths across one or more objects in the scene with one or more beams provided by one or more scanning devices that are separate from the mobile computer;
determining a plurality of events based on detection of one or more beam reflections corresponding to the one or more objects;
determining a plurality of trajectories based on the plurality of paths and the plurality of events, wherein each trajectory is a parametric representation of a one-dimensional curve segment in a three-dimensional space; and
augmenting the one or more images of the scene based on the plurality of trajectories.

2. The method of claim 1, wherein detecting the one or more beam reflections, further comprises:
detecting the one or more beam reflections by one or more event cameras included in the one or more scanning devices.

3. The method of claim 1, wherein determining the plurality of trajectories is based on one or more of triangulation or time-of-flight.

4. The method of claim 1, wherein augmenting the one or more images of the scene, further comprises:
embedding one or more artificial objects in the scene based on the plurality of trajectories, wherein a position, an orientation, and a visibility of the one or more artificial objects in the scene are based on the plurality of trajectories.

5. The method of claim 1, wherein augmenting the one or more images of the scene, further comprises:
tracking a position of one or more eyes of a user using a front facing frame camera; and
embedding one or more artificial objects in the scene based on the plurality of trajectories and the position of the one or more eyes of the user.

6. The method of claim 1, wherein the one or more scanning devices, further comprises:
a housing that is either embedded or attached to one or more of a headband, an armband, a visor, a necklace, clothing, a chest harness, a belt buckle, a headgear, a hat, a mobile phone case, a notebook computer, a mobile phone, eyewear.

7. The method of claim 1, further comprising:
varying one or more of a power or a wavelength of the one or more beams based on one or more of a distance to the one or more objects, an ambient light condition, motion of the one or more scanning devices, motion of the one or more objects, or power consumption.

8. The method of claim 1, wherein capturing the one or more images of the scene, further comprises:
deactivating the one or more beam generators for one or more portions of the images, wherein the one or more portions are captured absent interference by the one or more beams; and
employing the one or more portions to display the scene to a user.

9. The method of claim 1, further comprising:
capturing one or more other images of the scene with one or more other frame cameras included in one or more other mobile computers;
scanning a plurality of other paths across the one or more objects in the scene with one or more other beams from one or more other scanning devices;
determining a plurality of other events based on the one or more beams and the one or more other beam reflections corresponding to the one or more objects and detected by the one or more other scanning devices;
determining a plurality of other trajectories based on the plurality of paths and the plurality of other events; and
augmenting the scene based on the plurality of trajectories and the plurality of other trajectories.

10. A processor readable non-transitory storage media that includes instructions for sensing objects, wherein execution of the instructions by one or more processors on one or more network computers performs actions, comprising:
capturing one or more images of a scene with one or more frame cameras included in a mobile computer;
scanning a plurality of paths across one or more objects in the scene with one or more beams provided by one or more scanning devices that are separate from the mobile computer;
determining a plurality of events based on detection of one or more beam reflections corresponding to the one or more objects;
determining a plurality of trajectories based on the plurality of paths and the plurality of events, wherein each trajectory is a parametric representation of a one-dimensional curve segment in a three-dimensional space; and
augmenting the one or more images of the scene based on the plurality of trajectories.

11. The media of claim 10, wherein detecting the one or more beam reflections, further comprises:
detecting the one or more beam reflections by one or more event cameras included in the one or more scanning devices.

12. The media of claim 10, wherein determining the plurality of trajectories is based on one or more of triangulation or time-of-flight.

13. The media of claim 10, wherein augmenting the one or more images of the scene, further comprises:
embedding one or more artificial objects in the scene based on the plurality of trajectories, wherein a position, an orientation, and a visibility of the one or more artificial objects in the scene are based on the plurality of trajectories.

14. The media of claim 10, wherein augmenting the one or more images of the scene, further comprises:
tracking a position of one or more eyes of a user using a front facing frame camera; and
embedding one or more artificial objects in the scene based on the plurality of trajectories and the position of the one or more eyes of the user.

15. The media of claim 10, wherein the one or more scanning devices, further comprises:
a housing that is either embedded or attached to one or more of a headband, an armband, a visor, a necklace, clothing, a chest harness, a belt buckle, a headgear, a hat, a mobile phone case, a notebook computer, a mobile phone, eyewear.

16. The media of claim 10, further comprising:
varying one or more of a power or a wavelength of the one or more beams based on one or more of a distance to the one or more objects, an ambient light condition, motion of the one or more scanning devices, motion of the one or more objects, or power consumption.

17. The media of claim 10, wherein capturing the one or more images of the scene, further comprises:
deactivating the one or more beam generators for one or more portions of the images, wherein the one or more portions are captured absent interference by the one or more beams; and
employing the one or more portions to display the scene to a user.

18. The media of claim 10, further comprising:
capturing one or more other images of the scene with one or more other frame cameras included in one or more other mobile computers;
scanning a plurality of other paths across the one or more objects in the scene with one or more other beams from one or more other scanning devices;
determining a plurality of other events based on the one or more beams and the one or more other beam reflections corresponding to the one or more objects and detected by the one or more other scanning devices;
determining a plurality of other trajectories based on the plurality of paths and the plurality of other events; and
augmenting the scene based on the plurality of trajectories and the plurality of other trajectories.

19. A scanning device for sensing objects, comprising:
a memory that stores at least instructions; and
one or more processors configured that execute instructions that are configured to cause actions, including:
scanning a plurality of paths across one or more objects in a scene with one or more beams provided by one or more scanning devices;
determining a plurality of events based on detection of one or more beam reflections corresponding to the one or more objects;
determining a plurality of trajectories based on the plurality of paths and the plurality of events, wherein each trajectory is a parametric representation of a one-dimensional curve segment in a three-dimensional space; and
augmenting one or more images of the scene based on the plurality of trajectories, wherein the one or more images of the scene are captured by one or more frame cameras included in a mobile computer.

20. The scanning device of claim 19, wherein detecting the one or more beam reflections, further comprises:
detecting the one or more beam reflections by one or more event cameras included in the one or more scanning devices.

21. The scanning device of claim 19, wherein determining the plurality of trajectories is based on one or more of triangulation or time-of-flight.

22. The scanning device of claim 19, wherein augmenting the one or more images of the scene, further comprises:
embedding one or more artificial objects in the scene based on the plurality of trajectories, wherein a position, an orientation, and a visibility of the one or more artificial objects in the scene are based on the plurality of trajectories.

23. The scanning device of claim 19, wherein augmenting the one or more images of the scene, further comprises:
tracking a position of one or more eyes of a user using a front facing frame camera; and
embedding one or more artificial objects in the scene based on the plurality of trajectories and the position of the one or more eyes of the user.

24. The scanning device of claim 19, wherein the one or more scanning devices, further comprises:
a housing that is either embedded or attached to one or more of a headband, an armband, a visor, a necklace, clothing, a chest harness, a belt buckle, a headgear, a hat, a mobile phone case, a notebook computer, a mobile phone, eyewear.

25. The scanning device of claim 19, wherein the one or more processors of the scanning device are configured to execute instructions that are configured to cause actions, further comprising:
varying one or more of a power or a wavelength of the one or more beams based on one or more of a distance to the one or more objects, an ambient light condition, motion of the one or more scanning devices, motion of the one or more objects, or power consumption.

26. The scanning device of claim 19, wherein capturing the one or more images of the scene, further comprises:
deactivating the one or more beam generators for one or more portions of the images, wherein the one or more portions are captured absent interference by the one or more beams; and
employing the one or more portions to display the scene to a user.

27. The scanning device of claim 19, wherein the one or more processors of the scanning device are configured to execute instructions that are configured to cause actions, further comprising:
determining a plurality of other events based on one or more other beams and one or more other beam reflections corresponding to the one or more objects, wherein the one or more other beams are generated by one or more other scanning devices;
determining a plurality of other trajectories based on the plurality of paths and the plurality of other events; and
augmenting the scene based on the plurality of trajectories and the plurality of other trajectories.

28. A system for sensing objects:
a scanning device, comprising:
a memory that stores at least instructions; and
one or more processors that execute instructions that are configured to cause actions, including:
scanning a plurality of paths across one or more objects in the scene with one or more beams;
determining a plurality of events based on detection of one or more beam reflections corresponding to the one or more objects;
determining a plurality of trajectories based on the plurality of paths and the plurality of events, wherein each trajectory is a parametric representation of a one-dimensional curve segment in a three-dimensional space; and
augmenting the one or more images of the scene based on the plurality of trajectories; and
one or more mobile computers, comprising:
a memory that stores at least instructions; and
one or more processors that execute instructions that are configured to cause action, including:
capturing the one or more images of a scene with one or more frame cameras; and
displaying the one or more augmented images.

29. The system of claim 28, wherein detecting the one or more beam reflections, further comprises:
detecting the one or more beam reflections by one or more event cameras included in the one or more scanning devices.

30. The system of claim 28, wherein determining the plurality of trajectories is based on one or more of triangulation or time-of-flight.

31. The system of claim 28, wherein augmenting the one or more images of the scene, further comprises:
embedding one or more artificial objects in the scene based on the plurality of trajectories, wherein a position, an orientation, and a visibility of the one or more artificial objects in the scene are based on the plurality of trajectories.

32. The system method of claim 28, wherein augmenting the one or more images of the scene, further comprises:
tracking a position of one or more eyes of a user using a front facing frame camera; and
embedding one or more artificial objects in the scene based on the plurality of trajectories and the position of the one or more eyes of the user.

33. The system method of claim 28, wherein the one or more scanning devices, further comprises:
a housing that is either embedded or attached to one or more of a headband, an armband, a visor, a necklace, clothing, a chest harness, a belt buckle, a headgear, a hat, a mobile phone case, a notebook computer, a mobile phone, eyewear.

34. The system method of claim 28, further comprising:
varying one or more of a power or a wavelength of the one or more beams based on one or more of a distance to the one or more objects, an ambient light condition, motion of the one or more scanning devices, motion of the one or more objects, or power consumption.

35. The system method of claim 28, wherein capturing the one or more images of the scene, further comprises:
deactivating the one or more beam generators for one or more portions of the images, wherein the one or more portions are captured absent interference by the one or more beams; and
employing the one or more portions to display the scene to a user.
